(19) United States
(12) Patent Application Publication
(10) Pub. No.: US 2022/0164651 A1
(43) Pub. Date: May 26, 2022

(54) FEEDBACK MINING WITH DOMAIN-SPECIFIC MODELING

(71) Applicant: KOCH INDUSTRIES, INC., Wichita, KS (US)

(72) Inventor: Stephen J. MACKENZIE, Wichita, KS (US)

(21) Appl. No.: 17/430,901

(22) PCT Filed: Oct. 29, 2019
(86) PCT No.: PCT/IB2019/059248

§ 371 Date: Aug. 13, 2021

Related U.S. Application Data
(60) Provisional application No. 62/808,356, filed on Feb. 21, 2019.

(51) Int. Cl. G06N 3/08; G06Q 50/18; G06N 3/04

(52) U.S. Cl. CPC G06N 3/08; G06N 3/04; G06Q 50/184

(57) ABSTRACT

There is a need for more effective and efficient feedback mining systems. This need can be addressed by, for example, solutions for performing feedback mining with domain-specific modeling. In one example, a method includes processing each evaluator data object and an evaluation task data object to generate a particular credential score for the particular evaluator data object with respect to the evaluation task data object; for each feedback data object associated with a particular evaluator data object, processing the particular feedback data object and the credential score for the particular evaluator data object to generate a feedback score for the particular feedback data object; and process each feedback score for a feedback data object to generate a collaborative evaluation for the evaluation task data object.

### RELATED APPLICATION

This application claims priority to U.S. Provisional Application No. 62/808,356, filed on Feb. 21, 2019, which application is incorporated herein by reference in its entirety.

### BACKGROUND

Various embodiments of the present invention address technical challenges related to performing feedback mining. Existing feedback mining technologies are ill-suited to efficiently and reliably perform evaluation feedback mining. Various embodiments of the present address the shortcomings of the noted feedback mining systems and disclose various techniques for efficiently and reliably performing evaluation feedback mining.

### BRIEF SUMMARY

In general, embodiments of the present invention provide methods, apparatus, systems, computing devices, computing entities, and/or the like for performing evaluation feedback mining. Certain embodiments utilize systems, methods, and computer program products that perform evaluation feedback mining using one or more of credential scoring machine learning models, feedback scoring machine learning models, feedback aggregation machine learning models, evaluator correlation spaces, task feature spaces, preconfigured competence distributions for evaluator data objects, dynamic preconfigured competence distributions for evaluator data objects, domain-specific evaluation ranges, reward generation machine learning models, and/or the like. Certain embodiments utilize systems, methods, and computer program products that perform evaluation feedback mining in order to accomplish at least one of the following evaluation tasks: intellectual property asset validity analysis (e.g., patent validity analysis), intellectual property asset infringement analysis (e.g., patent infringement analysis), and intellectual property asset valuation analysis (e.g., patent valuation analysis).

Feedback mining refers to a set of problems that sit at the intersection of various emerging data analysis fields, such as natural language processing, predictive modeling, machine learning, and/or the like. One primary goal of feedback mining is to infer predictive insights about a predictive task based at least in part on feedback data provided by various commentators and/or observers that have expressed thoughts about the underlying predictive task. Existing feedback mining systems suffer from many shortcomings due to their inability to properly take into account domain-specific information and structures. For example, many existing feedback mining systems are agnostic to past data regarding backgrounds and activities of feedback providers that can provide important predictive insights about evaluative contributions of feedback providers. As another example, many existing feedback mining systems fail to generate evaluation designations that properly conform to semantic structures of the underlying domains within which the feedback mining systems are meant to be deployed and utilized. As yet another example, many existing feedback mining systems fail to generate and utilize independent data structures that define various features of evaluation tasks, feedback features, and evaluator features in a manner that facilitates effective and efficient modeling of predictive relationships between task features, feedback features, and evaluator features.

The inability of many existing feedback mining systems to properly integrate domain-specific information and structures has been particularly problematic for applications that seek to utilize feedback mining to generate automated evaluations for evaluation tasks that do not contain readily apparent answers. Examples of such automated evaluations include evaluations that require professional/expert analysis and may involve exercise of judgement in a manner that cannot always be properly encoded into the numeric structures of generic natural language processing models or generic machine learning models. For example, when performing invalidity analysis with respect to an intellectual property asset, infringement analysis with respect an intellectual property analysis, and/or valuation analysis with respect to an intellectual property asset, a feedback mining system will greatly benefit from integrating domain-specific information regarding semantic structures of the particular domain, desired output designations in the particular domain, evaluator background information concerning various evaluative tasks related to the particular domain, and/or the like. However, because of their inability to properly accommodate domain-specific information and structures, existing feedback mining systems are currently incapable of providing efficient and reliable solutions for performing automated evaluations for evaluation tasks that do not contain readily apparent answers. Accordingly, there is a technical need for feedback mining systems that accommodate domain-specific information and structures and integrate such domain-specific information and structures in performing efficient and reliable collaborative evaluations.

Various embodiments of the present invention address technical shortcomings of existing feedback mining systems. For example, various embodiments address technical shortcomings of existing feedback mining systems to properly take into account domain-specific information and structures. In some embodiments, a feedback mining system processes an evaluator data object which contains evaluator features associated with a feedback data object to extract information that can be used in determining the feedback score of the feedback data object with respect to a particular evaluation task. Such evaluator information may include statically-determined information such as academic degree information as well as dynamically-determined information which may be updated based at least in part on interactions of evaluator profiles with the feedback mining system. Therefore, by explicitly encoding evaluator features as an input to the multi-layered feedback mining solution provided by various embodiments of the present invention, the noted embodiments can provide a powerful mechanism for integrating domain-specific information related to evaluator background into the operations of the feedback mining system. Such evaluator-conscious analysis can greatly enhance the ability of feedback mining systems to integrate domain-specific information and thus perform effective and efficient evaluative analysis in professional/expert analytical domains.

As another example, various embodiments of the present invention provide independent unitary representations of evaluative task features as evaluation task data objects, feedback data features as feedback data objects, and evaluator features as evaluator data objects. By providing independent unitary representations of evaluative task features, feedback data features, and evaluator features, the noted embodiments provide a powerful data model that precisely and comprehensively maps the input space of a feedback mining system. In some embodiments, the data model is then used to create a multi-layered machine learning framework that first integrates evaluation task data objects and evaluator data objects to generate credential scores for evaluators with respect to particular evaluation tasks, then integrates credential scores and feedback data objects to generate feedback scores, and subsequently combines various feedback scores for various feedback objects to generate a collaborative evaluation based at least in part on aggregated yet distributed predictive knowledge of various evaluations by various evaluator profiles.

By providing independent unitary representations of evaluative task features, feedback data features, and evaluator features in addition to utilizing such independent unitary representations to design a multi-layered machine learning architecture, various embodiments of the present invention provide powerful solutions for performing feedback mining while taking into account domain-specific information and conceptual structures. In doing so, various embodiments of the present invention greatly enhance the ability of existing feedback mining systems to integrate domain-specific information and thus perform effective and efficient evaluative analysis in professional/expert analytical domains. Thus, various embodiments of the present invention address technical shortcomings of existing feedback mining systems and make important technical contributions to improving efficiency and/or reliability of existing feedback processing systems, such as efficiency and/or reliability of existing feedback processing systems in performing feedback processing using domain-specific information in professional/expert evaluation domains.

In accordance with one aspect of the present invention, a method is provided. In one embodiment, the method comprises: for each evaluator data object of one or more evaluator data objects, processing, by a credential scoring machine learning model, the corresponding evaluator data object and an evaluation task data object to generate a corresponding credential score for the corresponding evaluator data object with respect to the evaluation task data object; for each feedback data object of one or more feedback data objects associated with a corresponding evaluator data object, processing, by a feedback scoring machine learning model, the corresponding feedback data object and the corresponding credential score for the corresponding evaluator data object to generate a feedback score; and processing, by a feedback aggregation machine learning model, each feedback score for a feedback data object to generate a collaborative evaluation for the evaluation task data object.

In accordance with another aspect of the present invention, a computer program product is provided. The computer program product may comprise at least one computer-readable storage medium having computer-readable program code portions stored therein, the computer-readable program code portions comprising executable portions configured to: for each evaluator data object of one or more evaluator data objects, process, by a credential scoring machine learning model, the corresponding evaluator data object and an evaluation task data object to generate a corresponding credential score for the corresponding evaluator data object with respect to the evaluation task data object; for each feedback data object of one or more feedback data objects associated with a corresponding evaluator data object, process, by a feedback scoring machine learning model, the corresponding feedback data object and the corresponding credential score for the corresponding evaluator data object to generate a feedback score; and process, by a feedback aggregation machine learning model, each feedback score for a feedback data object to generate a collaborative evaluation for the evaluation task data object.

In accordance with yet another aspect of the present invention, an apparatus comprising at least one processor and at least one memory including computer program code is provided. In one embodiment, the at least one memory and the computer program code may be configured to, with the processor, cause the apparatus to: for each evaluator data object of one or more evaluator data objects, process, by a credential scoring machine learning model, the corresponding evaluator data object and an evaluation task data object to generate a corresponding credential score for the corresponding evaluator data object with respect to the evaluation task data object; for each feedback data object of one or more feedback data objects associated with a corresponding evaluator data object, process, by a feedback scoring machine learning model, the corresponding feedback data object and the corresponding credential score for the corresponding evaluator data object to generate a feedback score; and process, by a feedback aggregation machine learning model, each feedback score for a feedback data object to generate a collaborative evaluation for the evaluation task data object.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example collaborative evaluation computing entity in accordance with some embodiments discussed herein.

FIG. 3 provides an example provider feedback computing entity in accordance with some embodiments discussed herein.

FIG. 4 provides an example client computing entity in accordance with some embodiments discussed herein.

FIG. 5 is a data flow diagram of an example process for performing collaborative evaluation with respect to an evaluation task data object in accordance with some embodiments discussed herein.

FIG. 6 is an operational example of an evaluation task data object in accordance with some embodiments discussed herein.

FIG. 7 is an operational example of a feedback data object in accordance with some embodiments discussed herein.

FIG. 8 is an operational example of an evaluator data object in accordance with some embodiments discussed herein.

FIG. 9 is a data flow diagram of an example process for generating a feedback score for a feedback data object with respect to an evaluation task data object in accordance with some embodiments discussed herein.

FIG. 10 is a flowchart diagram of an example process for determining a credential score for an evaluator data object in accordance with some embodiments discussed herein.

FIG. 11 is an operational example of an evaluation correlation space in accordance with some embodiments discussed herein.

FIG. 12 is a flowchart diagram of an example process for determining a credential score based at least in part on task distance measures for ground-truth credential scores in accordance with some embodiments discussed herein.

FIG. 13 is an operational example of an evaluation task feature space in accordance with some embodiments discussed herein.

FIG. 14 is a data flow diagram of an example process for generating a collaborative evaluation based at least in part on feedback scores for various feedback data objects in accordance with some embodiments discussed herein.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. OVERVIEW, DEFINITIONS AND TECHNICAL IMPROVEMENTS

Discussed herein are methods, apparatus, systems, computing devices, computing entities, and/or the like for feedback mining with domain-specific modeling As will be recognized, however, the disclosed concepts can be used to perform any type of natural language processing analysis, any type of predictive data analysis, and/or any type of evaluative data analysis.

### Definitions of Certain Terms

The term “collaborative evaluation” may refer to a data object that includes one or more predictions generated based on feedback data objects associated with two or more evaluator objects. A collaborative evaluation may correspond to features of a predictive task defined by an evaluation task object. For example, an evaluation task object may indicate an asset valuation request. In response, a collaborative evaluation system may receive various feedback data objects each indicating an opinion of a particular evaluator user profile associated with a corresponding evaluator object about the asset valuation request. The collaborative evaluation system may then utilize the various feedback data objects to generate a collaborative evaluation that indicates an aggregate asset valuation score corresponding to the asset valuation request.

The term “evaluator object” may refer to a data object that includes information about one or more evaluator properties of a particular evaluator user profile. For example, an evaluator object may include information about one or more of the following: recorded technical expertise of the particular evaluator user profile, recorded technical experience of the particular evaluator user profile, past performance of the particular evaluator user profile, other evaluator user profiles' rating of the particular evaluator user profile. In some embodiments, fields of an evaluator object may be defined in accordance with various dimensions of a multi-dimensional evaluator correlation space, such as a multi-dimensional evaluator correlation space whose first dimension is associated with an educational expertise score, whose second dimension is associated with a professional expertise score, etc.

The term “evaluation task object” may refer to a data object that includes information about one or more evaluation properties of a requested prediction. For example, an evaluation task object may indicate an asset valuation request for a particular asset having particular properties. As another example, an evaluation valuation request may indicate a validity determination request for a particular intellectual property asset. As a further example, an evaluation valuation request may indicate an infringement determination request for a particular intellectual property asset. In some embodiments, fields of an evaluation task object may be defined in accordance with various dimensions of a multi-dimensional evaluation task correlation space, such as a multi-dimensional evaluation task correlation space whose first dimension is associated with a task meta-type indicator, whose second dimension is associated with a task category type indicator, etc.

The term “credential score” may refer to data that indicate an evaluation about relevance of evaluator properties of an evaluator object to requested prediction properties of an evaluation task object. For example, a credential score may indicate how relevant expertise and/or experience of an evaluator user profile associated with an evaluator object is to a requested prediction associated with an evaluation task object. The credential score may be generated by a credential scoring machine learning model (e.g., a neural network credential scoring machine learning model), where the credential scoring machine learning model is configured to process an evaluator object and an evaluation data object to generate a credential score for the evaluator object with respect to the evaluation data object. The credential scoring machine learning model may include at least one of an unsupervised machine learning model and/or a supervised machine learning model, e.g., a supervised machine learning model trained using data about past ratings of feedback data objects and/or past ground-truth information confirming or rejecting evaluations by particular evaluator user profiles.

The term “feedback data object” may refer to a data object that includes information about one or more feedback properties of a feedback data object by an evaluator object about an evaluation task object. In some embodiments, the feedback data object includes one or more of the following portions: (i) one or more numerical inputs (e.g., numerical inputs about a rating of a valuation of an asset, numerical inputs about likelihood of invalidity of an intellectual property asset, etc.), (ii) one or more categorical inputs (e.g., a categorical input about designation of an intellectual property asset as likely invalid), and (iii) one or more natural language inputs (e.g., unstructured text data indicating opinion of an evaluator user profile with respect to a requested prediction). In some embodiments, the format of the feedback data object is determined based at least in part on format definition data in the evaluator object and/or format definition data in the evaluation task object.

The term “feedback score” may refer to data that indicate an indication about predictive contribution of a feedback data object to generating a collaborative evaluation for an evaluation task data object, wherein the predictive contribution of the feedback data object is determined in part based on the credential score of the evaluator object associated with the feedback object. For example, a feedback data object indicating opinion of an expert valuator profile about low valuation of an asset may have a relatively higher feedback score and thus have a significant downward effect on the collaborative evaluation of the valuation of the asset. As another example, a feedback data object indicating opinion of an expert infringement analyst profile about low valuation of an asset may have a relatively lower feedback score and thus have a less significant downward effect on the collaborative evaluation of the valuation of the asset.

The term “evaluator feature” may refer to data that indicate an attribute category of an evaluator data object, where the values for the attribute category of the evaluator data object may be used to model the evaluator data object in a multi-dimensional evaluator correlation space in order to numerically compare the evaluator data object with one or more other evaluator data objects. Examples of evaluator features include evaluator features about recorded technical expertise of a corresponding evaluator data object, recorded technical experience of a corresponding evaluator data object, past performance of a corresponding evaluator data object, other evaluator user profiles' rating of a corresponding evaluator data object, etc.

The term “evaluator feature value” may refer to data that indicate a current value for an attribute category of an evaluator data object. Examples of evaluator feature values include evaluator feature values about recorded technical expertise of a corresponding evaluator data object, recorded technical experience of a corresponding evaluator data object, past performance of a corresponding evaluator data object, other evaluator user profiles' rating of a corresponding evaluator data object, etc.

The term “evaluator dimension value” may refer to data that indicate a value of an evaluator data object with respect to a particular dimension of a multi-dimensional evaluator correlation space in which the evaluator data object is mapped. For example, a multi-dimensional evaluator correlation space may have a first dimension associated with an educational expertise score of mapped evaluator data objects, a second dimension associated with a professional expertise score of mapped evaluator data objects, etc. In the noted embodiments, an evaluator dimension value for a mapped evaluator data object may indicate an educational expertise score for the mapped evaluator data object or a professional expertise score for the mapped evaluator data object.

The term “ground-truth evaluator data object” may refer to an evaluator data object with respect to which a ground-truth credential score is accessible. For example, a collaborative evaluation computing entity may access observed credential scores for particular ground-truth evaluator data object as part of the training data for the collaborative evaluation computing entity and utilize the observed credential scores to generate ground-truth evaluator data objects. The ground-truth evaluator data object can be used to generate a multi-dimensional evaluator correlation space that can in turn be used to perform cross-evaluator generation of credential scores.

The term “ground-truth credential score” may refer to data that indicate an observed credential score for an evaluator data object. The observed credential score for the evaluator data object may be determined based on past user actions of the evaluator data object, professional experience data for the evaluator data object, academic education data for the evaluator data object, etc. The ground-truth credential scores may be used to generate ground-truth evaluation data objects, which in turn facilitate performing cross-evaluator generation of credential scores.

The term “cluster distance value” may refer to data that indicate a measured and/or estimated distance of an input prediction point associated with input prediction inputs with a prediction point associated with a cluster generated by a machine learning model. For example, given a multi-dimensional evaluator correlation value, the cluster distance value for a particular evaluator data object may be determined based on a measure of Euclidean distance between a position of the particular evaluator data object with respect to the multi-dimensional evaluator correlation and a statistical measure of a cluster most object to the evaluator data object with respect to the multi-dimensional evaluator correlation.

The term “task distance measure” may refer to data that indicate a measure of modeling separation between two points in a multi-dimensional task correlation space, wherein each point in the two points is associated with a respective evaluation task data object. In some embodiments, the task distance measure is determined based on performing one or more computationally geometry operations within the multi-dimensional task correlation space. In some embodiments, the task distance measure is determined based on performing one or more matrix transformation operations with respect to a matrix defining parameters of the multi-dimensional task correlation space.

The term “evaluation task feature” may refer to data that indicate a current value for an attribute category of an evaluation task data object, where the values for the attribute category of the evaluator data object may be used to model the evaluator data object in a multi-dimensional task correlation space in order to numerically compare the evaluation task data object with one or more other evaluation task data objects. Examples of evaluation task features include evaluation task features about subject matter of a corresponding evaluation task data object, hierarchical type level of a corresponding evaluation task data object, completion due dates of a corresponding evaluation task data object, etc.

The term “competence designation” may refer to data that indicate a discrete category of particular competence scores associated with evaluator data objects, where the discrete category is selected from a group of discretely-defined categories of competence. For example, the group of discretely-defined categories of competence may indicate low range competence designation (e.g., a competence score that falls below a threshold), medium range competence designation, and large range competence designation.

The term “feedback evaluation value” may refer to data that indicates an inferred conclusion of the feedback data object with respect to the evaluation task data object. For example, the feedback evaluation value for a particular feedback data object with respect to a particular evaluation task data object related to patent validity of a particular patent may indicate an inferred conclusion of the feedback data object with respect to the patent validity of the particular patent (e.g., an inferred conclusion indicating one of high likelihood of patentability, low likelihood of patentability, high likelihood of unpatentability, low likelihood of unpatentability, even likelihood of patentability and unpatentability, and/or the like). As another example, the feedback evaluation value for a particular feedback data object with respect to a particular evaluation task data object related to infringement of a particular patent by a particular activity or product may indicate an inferred conclusion of the feedback data object with respect to infringement of the particular patent by the particular activity or product (e.g., an inferred conclusion indicating one of high likelihood of infringement, low likelihood of infringement, high likelihood of non-infringement, low likelihood of non-infringement, even likelihood of infringement and non-infringement, and/or the like).

The term “feedback credibility value” may refer to data that indicates an inferred credibility of the evaluator data object for the feedback data object with respect to the evaluation task data object. For example, the feedback credibility value for a particular feedback data object by a particular evaluator data object with respect to a particular evaluation task data object which relates to patent validity of a particular patent may indicate an inferred credibility of the particular evaluator data object for the feedback data object with respect to the patent validity of the particular patent (e.g., an inferred credibility indicating one of high credibility, moderate credibility, low credibility, and/or the like). As a further example, the feedback credibility value for a particular feedback data object by a particular evaluator data object with respect to a particular evaluation task data object which relates to infringement of a particular patent by a particular activity or product may indicate an inferred credibility of the particular evaluator data object 503 for the feedback data object 502 with respect to the infringement of a particular patent by the particular activity or product (e.g., an inferred credibility indicating one of high credibility, moderate credibility, low credibility, and/or the like).

The term “domain-specific evaluation range” may refer to data that indicates a range of domain-specific evaluation designations for a corresponding evaluation task data object. In some embodiments, the domain-specific evaluation range for a particular evaluation task data object is determined based on range definition data in the corresponding evaluation task data object. In some embodiments, generating a collaborative evaluation includes performing the following operations: (i) for each domain-specific candidate evaluation designation of the one or more domain-specific evaluation designations defined by the domain-specific evaluation range for the evaluation task data object, (a) identifying one or more designated feedback data objects of the one or more feedback data objects for the domain-specific evaluation designation based at least in part on each feedback evaluation value for a feedback data object of the one or more feedback data objects, and (b) generating a designation score for the domain-specific evaluation designation based at least in part on each feedback credibility value for a designated feedback data object of the one or more designated feedback data objects for the domain-specific evaluation designation, and (ii) generating the collaborative evaluation 521 based at least in part on each designation score for a domain-specific evaluation designation of the one or more domain-specific evaluation designations.

The term “domain-specific evaluation designation” may refer to data indicating possible value of a domains-specific evaluation range. Examples of domain-specific evaluation designations include a domain-specific evaluation designations indicating high likelihood of patentability of a patent, a domain-specific evaluation designations indicating low likelihood of patentability of a patent, a domain-specific evaluation designations indicating high likelihood of unpatentability of a patent, a domain-specific evaluation designations indicating low likelihood of unpatentability of a patent, a domain-specific evaluation designations indicating an even likelihood of patentability and unpatentability of a patent, and/or the like.

The term “evaluator contribution” may refer to data indicating an inferred significance of one or more feedback data objects associated with an evaluator data object to determining a collaborative evaluation. In some embodiments, to determine the evaluator contribution value for an evaluator data object with respect to the collaborative evaluation, a feedback aggregation engine takes into account at least one of the following: (i) the credential score of the evaluator data object with respect to the evaluation task data object associated with the collaborative evaluation, (ii) the preconfigured competence distribution for the evaluator data object, (iii) the dynamic competence distribution for the evaluator data object, (iv) the feedback scores for any feedback data objects 502 used to generate the collaborative evaluation which are also associated with the evaluator data object, and (v) the feedback scores for any feedback data objects associated with the evaluation task data object for the collaborative evaluation which are also associated with the evaluator data object.

The term “evaluation utility determination” may refer to data indicating an inferred significance of any benefits generated by a collaborative evaluation. For example, the evaluation utility determination for a collaborative evaluation may be determined based at least in part on the monetary reward generated by a collaborative evaluation computing entity as a result of generating the collaborative evaluation. As another example, the evaluation utility determination for a collaborative evaluation may be determined based at least in part on the increased user visitation reward generated by the collaborative evaluation computing entity 106 as a result of generating the collaborative evaluation. As a further example, the evaluation utility determination for a collaborative evaluation may be determined based at least in part on the increased user registration reward generated by the collaborative evaluation computing entity 106 as a result of generating the collaborative evaluation.

### Technical Problems

Feedback mining refers to a set of problems that sit at the intersection of various emerging data analysis fields, such as natural language processing, predictive modeling, machine learning, and/or the like. One primary goal of feedback mining is to infer predictive insights about a predictive task based at least in part on feedback data provided by various commentators and/or observers that have expressed thoughts about the underlying predictive task. Existing feedback mining systems suffer from many shortcomings due to their inability to properly take into account domain-specific information and structures. For example, many existing feedback mining systems are agnostic to past data regarding backgrounds and activities of feedback providers that can provide important predictive insights about evaluative contributions of feedback providers. As another example, many existing feedback mining systems fail to generate evaluation designations that properly conform to semantic structures of the underlying domains within which the feedback mining systems are meant to be deployed and utilized. As yet another example, many existing feedback mining systems fail to generate and utilize independent data structures that define various features of evaluation tasks, feedback features, and evaluator features in a manner that facilitates effective and efficient modeling of predictive relationships between task features, feedback features, and evaluator features.

The inability of many existing feedback mining systems to properly integrate domain-specific information and structures has been particularly problematic for applications that seek to utilize feedback mining to generate automated evaluations for evaluation tasks that do not contain readily apparent answers. Examples of such automated evaluations include evaluations that require professional/expert analysis and may involve exercise of judgement in a manner that cannot always be properly encoded into the numeric structures of generic natural language processing models or generic machine learning models. For example, when performing invalidity analysis with respect to an intellectual property asset, infringement analysis with respect an intellectual property analysis, and/or valuation analysis with respect to an intellectual property asset, a feedback mining system will greatly benefit from integrating domain-specific information regarding semantic structures of the particular domain, desired output designations in the particular domain, evaluator background information concerning various evaluative tasks related to the particular domain, and/or the like. However, because of their inability to properly accommodate domain-specific information and structures, existing feedback mining systems are currently incapable of providing efficient and reliable solutions for performing automated evaluations for evaluation tasks that do not contain readily apparent answers. Accordingly, there is a technical need for feedback mining systems that accommodate domain-specific information and structures and integrate such domain-specific information and structures in performing efficient and reliable collaborative evaluations.

### Technical Solutions

Various embodiments of the present invention address technical shortcomings of existing feedback mining systems. For example, various embodiments address technical shortcomings of existing feedback mining systems to properly take into account domain-specific information and structures. In some embodiments, a feedback mining system processes an evaluator data object which contains evaluator features associated with a feedback data object to extract information that can be used in determining the feedback score of the feedback data object with respect to a particular evaluation task. Such evaluator information may include statically-determined information such as academic degree information as well as dynamically-determined information which may be updated based at least in part on interactions of evaluator profiles with the feedback mining system. Therefore, by explicitly encoding evaluator features as an input to the multi-layered feedback mining solution provided by various embodiments of the present invention, the noted embodiments can provide a powerful mechanism for integrating domain-specific information related to evaluator background into the operations of the feedback mining system. Such evaluator-conscious analysis can greatly enhance the ability of feedback mining systems to integrate domain-specific information and thus perform effective and efficient evaluative analysis in professional/expert analytical domains.

As another example, various embodiments of the present invention provide independent unitary representations of evaluative task features as evaluation task data objects, feedback data features as feedback data objects, and evaluator features as evaluator data objects. By providing independent unitary representations of evaluative task features, feedback data features, and evaluator features, the noted embodiments provide a powerful data model that precisely and comprehensively maps the input space of a feedback mining system. In some embodiments, the data model is then used to create a multi-layered machine learning framework that first integrates evaluation task data objects and evaluator data objects to generate credential scores for evaluators with respect to particular evaluation tasks, then integrates credential scores and feedback data objects to generate feedback scores, and subsequently combines various feedback scores for various feedback objects to generate a collaborative evaluation based at least in part on aggregated yet distributed predictive knowledge of various evaluations by various evaluator profiles.

By providing independent unitary representations of evaluative task features, feedback data features, and evaluator features in addition to utilizing such independent unitary representations to design a multi-layered machine learning architecture, various embodiments of the present invention provide powerful solutions for performing feedback mining while taking into account domain-specific information and conceptual structures. In doing so, various embodiments of the present invention greatly enhance the ability of existing feedback mining systems to integrate domain-specific information and thus perform effective and efficient evaluative analysis in professional/expert analytical domains. Thus, various embodiments of the present invention address technical shortcomings of existing feedback mining systems and make important technical contributions to improving efficiency and/or reliability of existing feedback processing systems, such as efficiency and/or reliability of existing feedback processing systems in performing feedback processing using domain-specific information in professional/expert evaluation domains.

### II. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### III. EXEMPLARY SYSTEM ARCHITECTURE

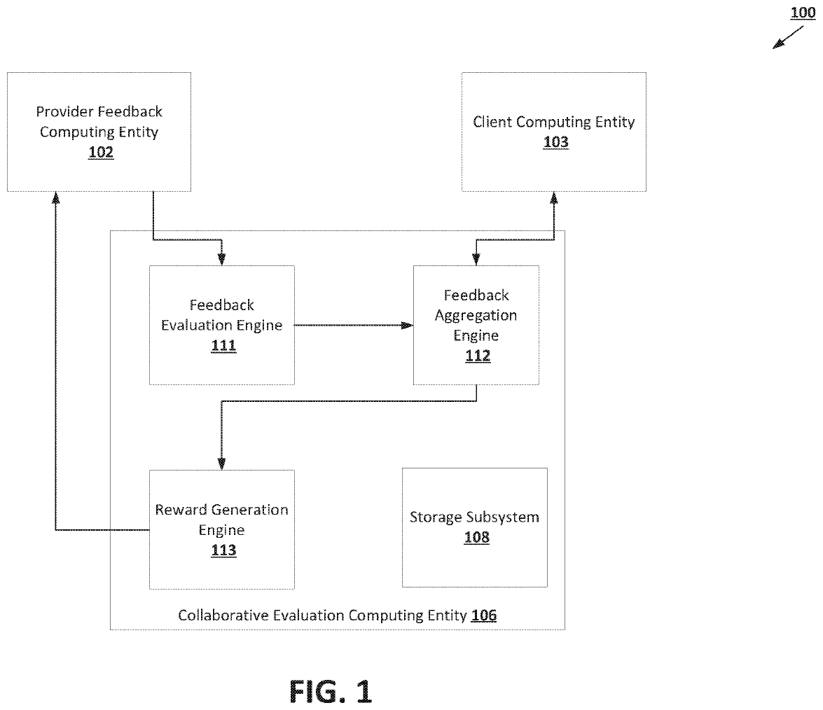

FIG. 1 is a schematic diagram of an example architecture 100 for performing feedback mining with domain-specific modeling. The architecture 100 includes one or more provider feedback computing entities 102, a collaborative evaluation computing entity 106, and one or more client computing entities 103. The collaborative evaluation computing entity 106 may be configured to communicate with at least one of the provider feedback computing entities 102 and the client computing entities 103 over a communication network (not shown). The communication network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The collaborative evaluation computing entity 106 may be configured to perform collaborative evaluations based at least in part on feedback data provided by provider feedback computing entities 102 in order to generate collaborative evaluations and provide the generated collaborative evaluations to the client computing entities 103, e.g., in response to requests by the client computing entities 103. For example, the collaborative evaluation computing entity 106 may be configured to perform automated asset valuations based at least in part on expert feedback data provided by the provider feedback computing entities 102 and provide the generated asset valuations to requesting client computing entities 103. The collaborative evaluation computing entity 106 may further be configured to generate reward determinations for feedback contributions by provider feedback computing entities 102 and transmit rewards corresponding to the generated reward determinations to the corresponding provider feedback computing entities 102.

The collaborative evaluation computing entity 106 includes a feedback evaluation engine 111, a feedback aggregation engine 112, a reward generation engine 113, and a storage subsystem 108. The feedback evaluation engine 111 may be configured to process particular feedback data provided by a provider feedback computing entity 102 to determine a feedback score for the particular feedback data with respect to an evaluation task. In some embodiments, the feedback score of particular feedback data with respect to an evaluation task indicates an evaluation of the particular feedback data in response to the evaluation task as well as a competence of the evaluator associated with the particular feedback data in subject areas related to the evaluation task. The feedback aggregation engine 112 may be configured to aggregate various feedback data objects related to an evaluation task to determine a collaborative evaluation pertaining to the evaluation task. The reward generation engine 113 may be configured to generate a reward for an evaluator based at least in part on an estimated contribution of the feedback data authored by the evaluator to the collaborative evaluation as well as a measure of utility of the collaborative evaluation.

The storage subsystem 108 may be configured to store data received from at least one of the provider feedback computing entities 102 and the client computing entities 103. The storage subsystem 108 may further be configured to store data associated with at least one machine learning model utilized by at least one of the feedback evaluation engine 111, the feedback aggregation engine 112, and the reward generation engine 113. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Collaborative Evaluation Computing Entity

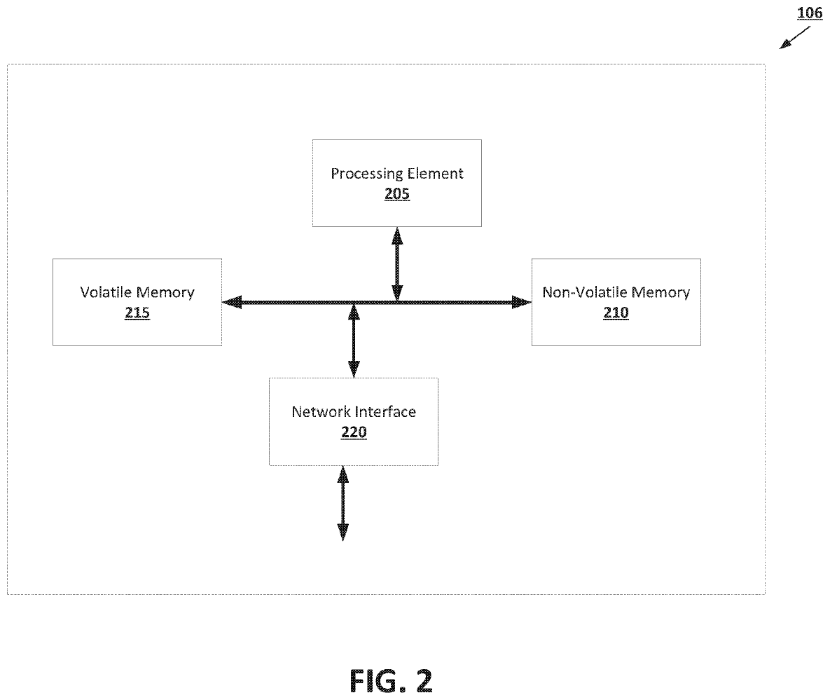

FIG. 2 provides a schematic of a collaborative evaluation computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the collaborative evaluation computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the collaborative evaluation computing entity 106 may include or be in communication with one or more processing elements 205 (also referred to as processors, processing circuitry, and/or similar terms used herein interchangeably) that communicate with other elements within the collaborative evaluation computing entity 106 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the collaborative evaluation computing entity 106 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the collaborative evaluation computing entity 106 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the collaborative evaluation computing entity 106 with the assistance of the processing element 205 and operating system.

As indicated, in one embodiment, the collaborative evaluation computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the collaborative evaluation computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the collaborative evaluation computing entity 106 may include or be in communication with one or more input elements, such as a keyboard input, a mouse input, a touch screen/display input, motion input, movement input, audio input, pointing device input, joystick input, keypad input, and/or the like. The collaborative evaluation computing entity 106 may also include or be in communication with one or more output elements (not shown), such as audio output, video output, screen/display output, motion output, movement output, and/or the like.

### Exemplary Provider Feedback Computing Entity

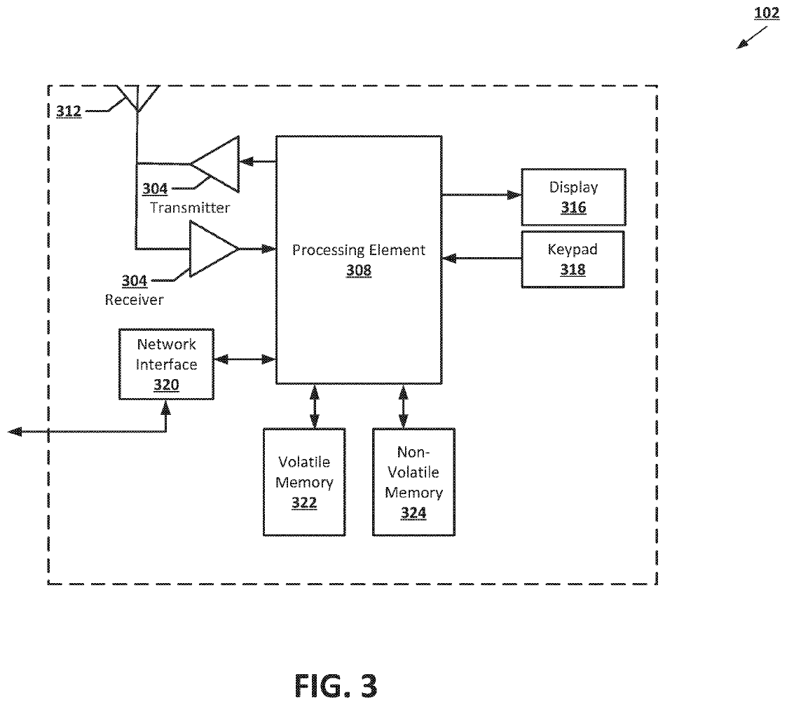

FIG. 3 provides an illustrative schematic representative of a provider feedback computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Provider feedback computing entities 102 can be operated by various parties. As shown in FIG. 3, the provider feedback computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling data in accordance with air interface standards of applicable wireless systems. In this regard, the provider feedback computing entity 102 may be capable of operating with one or more air interface standards, communication protocols, modulation types, and access types. More particularly, the provider feedback computing entity 102 may operate in accordance with any of a number of wireless communication standards and protocols, such as those described above with regard to the collaborative evaluation computing entity 106. In a particular embodiment, the provider feedback computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the provider feedback computing entity 102 may operate in accordance with multiple wired communication standards and protocols, such as those described above with regard to the collaborative evaluation computing entity 106 via a network interface 320.

Via these communication standards and protocols, the provider feedback computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The provider feedback computing entity 102 can also download changes, add-ons, and updates, for instance, to its firmware, software (e.g., including executable instructions, applications, program modules), and operating system.

According to one embodiment, the provider feedback computing entity 102 may include location determining aspects, devices, modules, functionalities, and/or similar words used herein interchangeably. For example, the provider feedback computing entity 102 may include outdoor positioning aspects, such as a location module adapted to acquire, for example, latitude, longitude, altitude, geocode, course, direction, heading, speed, universal time (UTC), date, and/or various other data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location data can be determined by triangulating the provider feedback computing entity's 102 position in connection with a variety of other systems, including cellular towers, Wi-Fi access points, and/or the like. Similarly, the provider feedback computing entity 102 may include indoor positioning aspects, such as a location module adapted to acquire, for example, latitude, longitude, altitude, geocode, course, direction, heading, speed, time, date, and/or various other data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The provider feedback computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the provider feedback computing entity 102 to interact with and/or cause display of data from the collaborative evaluation computing entity 106, as described herein. The user input interface can comprise any of a number of devices or interfaces allowing the provider feedback computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the provider feedback computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The provider feedback computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the provider feedback computing entity 102. As indicated, this may include a user application that is resident on the entity or accessible through a browser or other user interface for communicating with the collaborative evaluation computing entity 106 and/or various other computing entities.

In another embodiment, the provider feedback computing entity 102 may include one or more components or functionality that are the same or similar to those of the collaborative evaluation computing entity 106, as described in greater detail above. As will be recognized, these architectures and descriptions are provided for exemplary purposes only and are not limiting to the various embodiments.

In various embodiments, the provider feedback computing entity 102 may be embodied as an artificial intelligence (AI) computing entity, such as an Amazon Echo, Amazon Echo Dot, Amazon Show, Google Home, and/or the like. Accordingly, the provider feedback computing entity 102 may be configured to provide and/or receive data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Exemplary Client Computing Entity

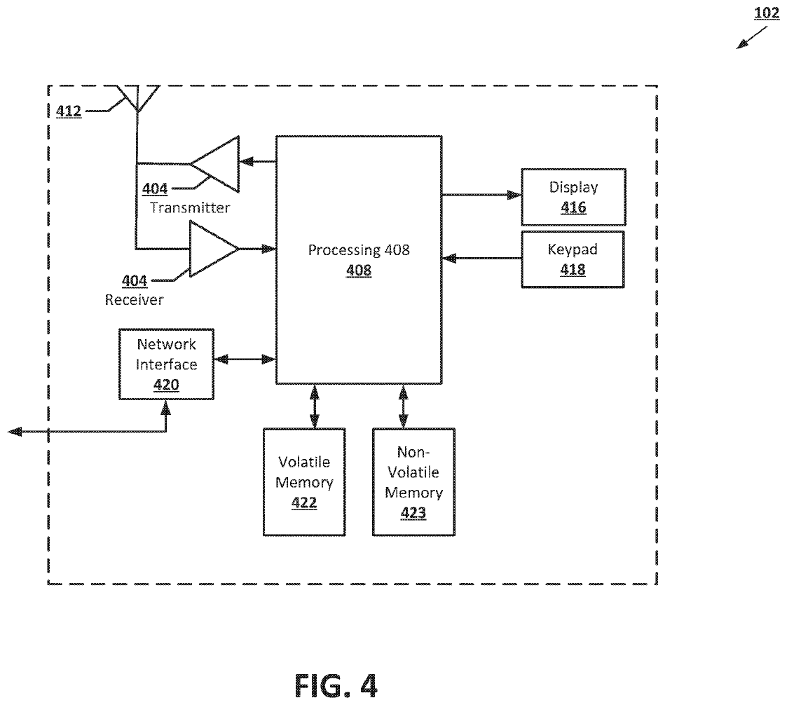

FIG. 4 provides an illustrative schematic representative of a client computing entity 103 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 103 can be operated by various parties. As shown in FIG. 4, the client computing entity 103 can include an antenna 412, a transmitter 404 (e.g., radio), a receiver 406 (e.g., radio), and a processing element 408 (e.g., CPLDs, microprocessors, multi-core processors, coprocessing entities, ASIPs, microcontrollers, and/or controllers) that provides signals to and receives signals from the transmitter 404 and receiver 406, correspondingly.

The signals provided to and received from the transmitter 404 and the receiver 406, correspondingly, may include signaling data in accordance with air interface standards of applicable wireless systems. In this regard, the client computing entity 103 may be capable of operating with one or more air interface standards, communication protocols, modulation types, and access types. More particularly, the client computing entity 103 may operate in accordance with any of a number of wireless communication standards and protocols, such as those described above with regard to the collaborative evaluation computing entity 106. In a particular embodiment, the client computing entity 103 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 103 may operate in accordance with multiple wired communication standards and protocols, such as those described above with regard to the collaborative evaluation computing entity 106 via a network interface 420.

Via these communication standards and protocols, the client computing entity 103 can communicate with various other entities using concepts such as USSD, SMS, MMS, DTMF, and/or SIM dialer. The client computing entity 103 can also download changes, add-ons, and updates, for instance, to its firmware, software (e.g., including executable instructions, applications, program modules), and operating system.

According to one embodiment, the client computing entity 103 may include location determining aspects, devices, modules, functionalities, and/or similar words used herein interchangeably. For example, the client computing entity 103 may include outdoor positioning aspects, such as a location module adapted to acquire, for example, latitude, longitude, altitude, geocode, course, direction, heading, speed, UTC, date, and/or various other data. In one embodiment, the location module can acquire data, sometimes known as ephemeris data, by identifying the number of satellites in view and the relative positions of those satellites (e.g., using GPS). The satellites may be a variety of different satellites, including LEO satellite systems, DOD satellite systems, the European Union Galileo positioning systems, the Chinese Compass navigation systems, Indian Regional Navigational satellite systems, and/or the like. This data can be collected using a variety of coordinate systems, such as the DD, DMS, UTM, UPS coordinate systems, and/or the like. Alternatively, the location data can be determined by triangulating the client computing entity's 103 position in connection with a variety of other systems, including cellular towers, Wi-Fi access points, and/or the like. Similarly, the client computing entity 103 may include indoor positioning aspects, such as a location module adapted to acquire, for example, latitude, longitude, altitude, geocode, course, direction, heading, speed, time, date, and/or various other data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 103 may also comprise a user interface (that can include a display 416 coupled to a processing element 408) and/or a user input interface (coupled to a processing element 408). For example, the user interface may be a user application, browser, user interface, and/or similar words used herein interchangeably executing on and/or accessible via the client computing entity 103 to interact with and/or cause display of data from the collaborative evaluation computing entity 106, as described herein. The user input interface can comprise any of a number of devices or interfaces allowing the client computing entity 103 to receive data, such as a keypad 418 (hard or soft), a touch display, voice/speech or motion interfaces, or other input device. In embodiments including a keypad 418, the keypad 418 can include (or cause display of) the conventional numeric (0-9) and related keys (#, *), and other keys used for operating the client computing entity 103 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 103 can also include volatile storage or memory 422 and/or non-volatile storage or memory 424, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 103. As indicated, this may include a user application that is resident on the entity or accessible through a browser or other user interface for communicating with the collaborative evaluation computing entity 106 and/or various other computing entities.

In another embodiment, the client computing entity 103 may include one or more components or functionality that are the same or similar to those of the collaborative evaluation computing entity 106, as described in greater detail above. As will be recognized, these architectures and descriptions are provided for exemplary purposes only and are not limiting to the various embodiments.

In various embodiments, the client computing entity 103 may be embodied as an artificial intelligence (AI) computing entity, such as an Amazon Echo, Amazon Echo Dot, Amazon Show, Google Home, and/or the like. Accordingly, the client computing entity 103 may be configured to provide and/or receive data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### IV. EXEMPLARY SYSTEM OPERATIONS

In general, embodiments of the present invention provide methods, apparatus, systems, computing devices, computing entities, and/or the like for performing evaluation feedback mining. Certain embodiments utilize systems, methods, and computer program products that perform evaluation feedback mining using one or more of credential scoring machine learning models, one or more feedback scoring machine learning models, one or more feedback aggregation machine learning models, one or more evaluator correlation spaces, one or more task feature spaces, one or more preconfigured competence distributions for evaluator data objects, one or more dynamic preconfigured competence distributions for evaluator data objects, one or more domain-specific evaluation ranges, one or more reward generation machine learning models, and/or the like.

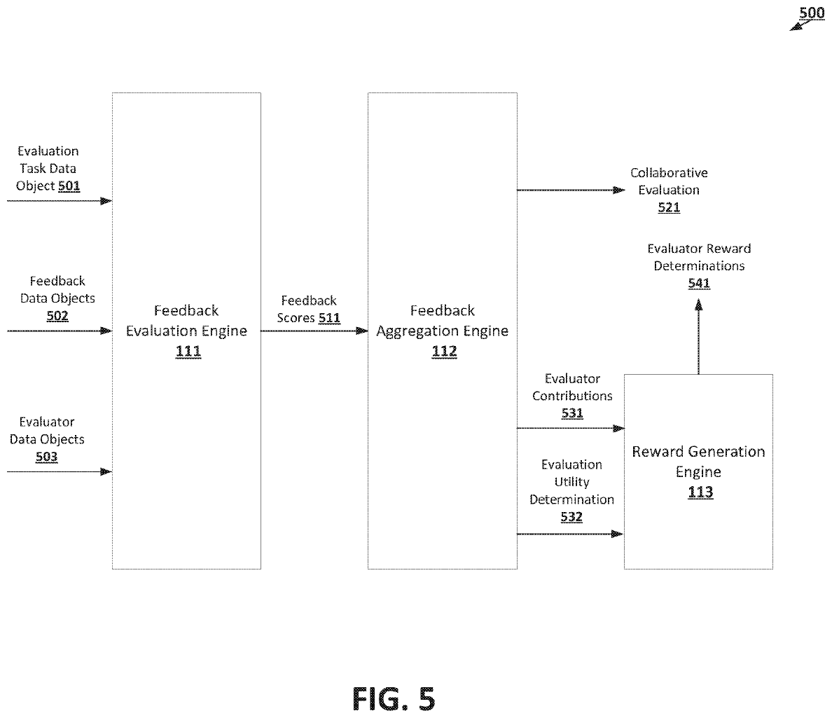

FIG. 5 is a flowchart diagram of an example process 500 for performing collaborative evaluation with respect to an evaluation task data object 501. Via the various steps/operations of process 500, the collaborative evaluation computing entity 106 can utilize feedback data from a plurality of evaluators (e.g., evaluator profiles) to generate comprehensive evaluations for various evaluation task data objects and maintain temporal performance achievement data for each of the plurality of collaborator profiles.

In one embodiment, the process begins when the feedback evaluation engine 111 of the collaborative evaluation computing entity 106 obtains the following input data objects: an evaluation task data object 501 defining an evaluation task, one or more feedback data objects 502 each defining feedback by a particular evaluator profile with respect to the evaluation task, and a plurality of evaluator data objects each defining evaluator features for a corresponding evaluator profile. The mentioned three input object types are described in greater detail below.

The evaluation task data object 501 may define one or more task features for a particular evaluation task object. The evaluation task may include application of any predictive data analysis routine to particular input data to obtain desired output data. Examples of evaluation task data objects 501 include evaluation task data objects related to one or more of valuation, scope determination, quality determination, validity determination, health determination, and/or the like. In some embodiments, an evaluation task data object 501 may relate to a question without a readily determinable answer which has bearings on matter of professional/expert judgment. Examples of such questions include various legal questions, medical questions, business strategy planning questions, and/or the like. In some embodiments, the evaluation task data object 501 is associated with a validity prediction for a particular intellectual property asset (e.g., a particular patent asset or a particular trademark asset). In some embodiments, the evaluation task data object 501 is associated with an infringement prediction for a particular intellectual property asset (e.g., a particular patent asset or a particular trademark asset). In some embodiments, the evaluation task data object 501 is associated with a value prediction for a particular intellectual property asset (e.g., a particular patent asset or a particular trademark asset).

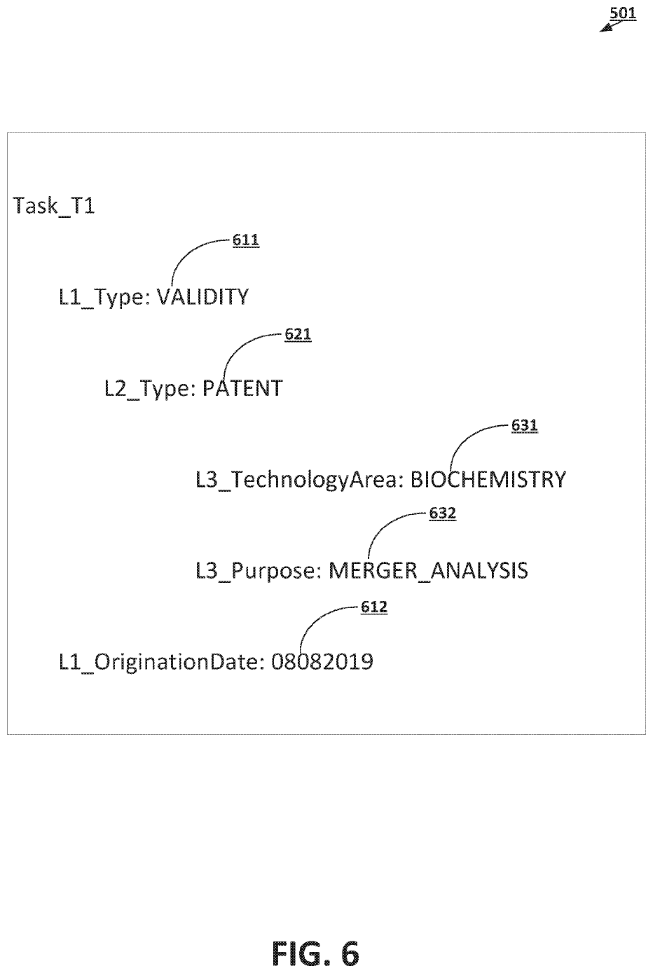

In some embodiments, receiving the evaluation task data object 501 includes generating the evaluation task data object 501 based at least in part on one or more task features for a particular evaluation task (e.g., a particular predictive data analysis task). The one or more task features for a particular evaluation task may be utilized to map the particular evaluation task in a multi-dimensional task space. The one or more task features for a particular evaluation task may have a hierarchical structure, such that at least a first one of the one or more task features for a particular evaluation task depends from at least a second one of the one or more task features for a particular evaluation task. For example, FIG. 6 provides an operational example of a hierarchical evaluation task data object 501 having three hierarchical levels, as described below. As depicted in FIG. 6, the hierarchical evaluation task data object 501 includes (on a first hierarchical level) a level-one task-type feature 611 (e.g., a task meta-type feature) which indicates that the hierarchical evaluation task data object 501 relates to property valuation and a level-one task-origination-date feature 612 (e.g., an object creation-date feature) which indicates that the hierarchical evaluation task data object 501 was created on Aug. 8, 2019. The hierarchical evaluation task data object 501 further includes (on a second hierarchical level) a level-two task-type feature 621 which depends from the level-one task-type feature 611 (e.g., a task sub-type feature) and indicates that indicates that the property-valuation-related hierarchical evaluation task data object 501 relates to a patent property valuation. The hierarchical evaluation task data object 501 further includes (on a third hierarchical level): (i) a first level-three task-type feature 631 (e.g., a patent technology-area feature) which depends from the level-two task-type feature 621 and indicates that the patent-valuation-related hierarchical evaluation task data object 501 relates to a biotechnology patent; and (ii) a second level-three task-type feature 632 (e.g., a valuation purpose feature) which depends from the level-two task-type feature 621 and indicates that the patent-valuation-related hierarchical evaluation task data object

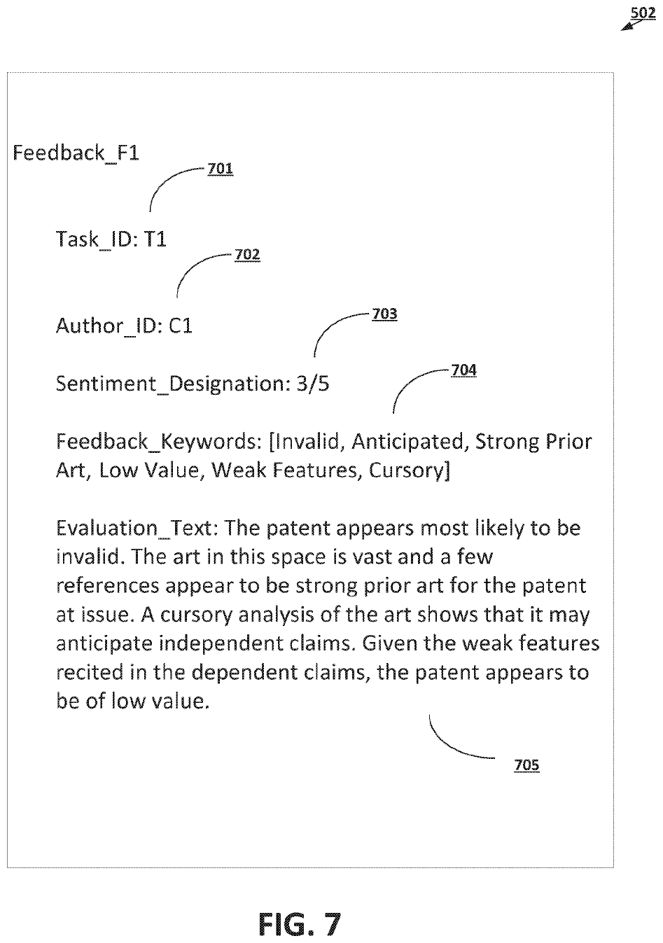

The feedback data objects 502 may describe feedback properties associated with an expressed opinion (e.g., an expressed expert opinion) related to the evaluation task data object. In some embodiments, each feedback data object 502 is associated with one or more feedback features. The feedback features for a particular feedback data object 502 may include one or more unstructured features for the particular feedback data object 502 and/or one or more structured features for the particular feedback data object502. For example, the unstructured features for a feedback data object 502 may include at least a portion of one or more natural language input segments associated with the feedback data object 502. As another example, the structured features for a feedback data object 502 may include one or more sentiment designations included in the feedback data object 502 (e.g., one or more n-star ratings by a feedback author in response to a particular evaluation task). As a further example, the structured features for a feedback data object 502 may include one or more natural language processing designations for particular unstructured natural language data associated with the feedback data object 502, where the one or more natural language processing designations for the unstructured natural language data may be generated by processing the unstructured natural language data using one or more natural language processing routines. An operational example of a feedback data object 502 that relates to the evaluation task data object 501 of FIG. 6 is presented in FIG. 7. As depicted in FIG. 7, the feedback data object 502 includes the following feedback feature: (i) a task identifier feedback feature 701, (ii) an author identifier feedback feature 702, (iii) a sentiment designation feedback feature 703, (iv) an evaluation text keyword identification vector feedback feature 704, and (v) an evaluation text string feedback feature 705.

An evaluator data object 503 for a feedback data object 502 may include data associated with an evaluator (e.g., an expert evaluator) user profile associated with the feedback data object. In some embodiments, each evaluator data object 503 is associated with a plurality of evaluator features, where the plurality of evaluator features for a particular evaluator data object 503 may include at least one of the following: (i) a preconfigured competence distribution for the particular evaluator data object 503 with respective to a plurality of competence designations, and (ii) a dynamic competence distribution for the particular evaluator data object 503 with respective to the plurality of competence designations.

In some embodiments, the preconfigured competence distribution for an evaluator data object 503 may be determined based at least in part on statically-determined data associated with the evaluator data object 503, e.g., based at least in part on data that will not be affected by the interaction of a user entity associated with the evaluator data object 503 and the collaborative evaluation computing entity 106, such as based at least in part on academic-degree data, years-of-experience data, professional/expert recognition data, and/or the like. In some embodiments, the dynamic competence distribution for an evaluator data object 503 may be determined based at least in part on dynamically-determined data associated with the evaluator data object 503, e.g., based at least in part on data that will be determined at least in part based at least in part on interactions of a user entity associated with the evaluator data object 503 and the collaborative evaluation computing entity 106, such as based at least in part on data describing past acceptance of evaluations by the user entity by the wider evaluator community, past ratings of the evaluations by the user entity by the wider evaluator community, past user activity history of the user entity, and/or the like.

In some embodiments, the dynamic competence distribution for a particular evaluator data object 503 is determined using an online scoring machine learning model configured to sequentially update the dynamic competence distribution based at least in part on one or more incoming feedback evaluation data objects for the a particular evaluator data object, where an incoming feedback evaluation data object for a particular evaluator data object may be any data object that provides an evaluation and/or a rating of a feedback data object associated with the particular evaluator data object 503. In some embodiments, the online scoring machine learning model used to determine the dynamic competence distribution for a particular evaluator data object 503 is a follow-the-regularized-leader (FTRL) online machine learning model.

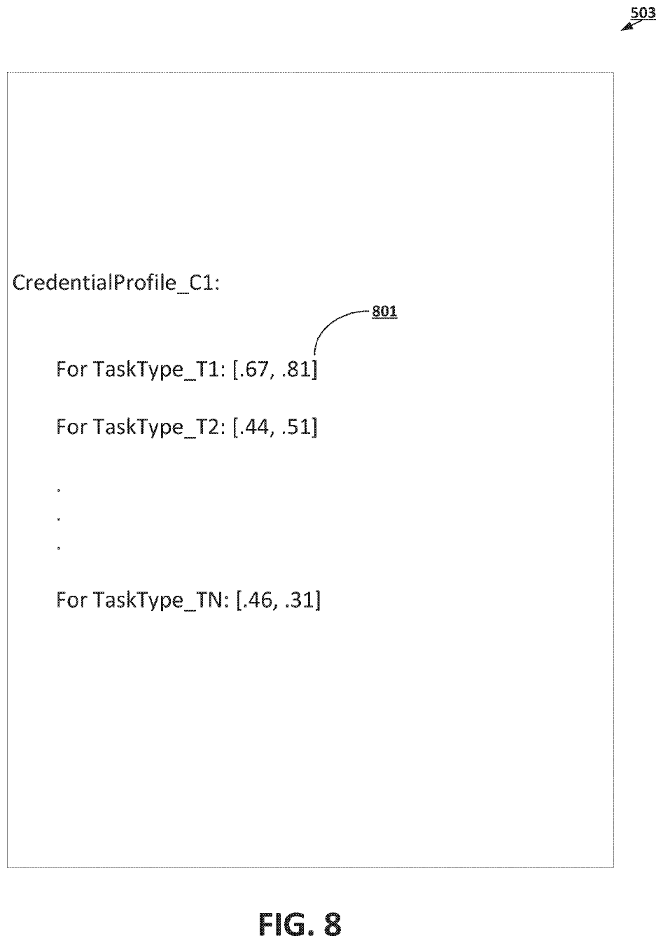

An operational example of an evaluator data object 800 associated with an author of the feedback data object 502 is presented in FIG. 8. As depicted in FIG. 8, the evaluator data object 800 includes various per-task-type competence distribution vectors, such as the per-task competence distribution vector 801. Each per-task-type competence distribution vector in the evaluator data object 800 may indicate pre-configured and dynamic competence distributions of the evaluator data object 800 with respect to the various task types, where each of the various task types may be defined using one or more task types features such as one or more hierarchically-defined task type features. For example, a particular per-task-type competence distribution vector may indicate pre-configured and dynamic competence distributions of the evaluator data object 800 with respect to a task type related to patent valuation. As another example, a particular per-task-type competence distribution vector may indicate pre-configured and dynamic competence distributions of the evaluator data object 800 with respect to a task related to patent infringement analysis of a software patent related to computer networking. As yet another example, a particular per-task-type competence distribution vector may indicate pre-configured and dynamic competence distributions of the evaluator data object 800 with respect to a task type related patent validity analysis of biochemical patents for the purposes of litigation defense.

Returning to FIG. 5, the feedback evaluation engine 111 utilizes the evaluation task data object 501, the feedback data objects 502, and the evaluator data projects 503 to generate a feedback score 511 for each feedback data object 502 with respect to the evaluation task data object 501. In some embodiments, the feedback score of a particular feedback data object 502 with respect to the evaluation task data object 501 is an estimated measure of contribution of data for the particular feedback data object 502 to resolving an evaluation task defined by the evaluation task data object 501. In some embodiments, each feedback score for a feedback data object includes a feedback evaluation value for the feedback data object 502 with respect to the evaluation task data object 501 and a feedback credibility value for the feedback data object 502 with respect to the evaluation task data object 501. In some embodiments, the feedback evaluation value for the feedback data object 502 with respect to the evaluation task data object 501 indicates an inferred conclusion of the feedback data object 502 with respect to the evaluation task data object 501. In some embodiments, the feedback credibility value of the feedback data object 502 with respect to the evaluation task data object 501 indicates an inferred credibility of the evaluator data object 503 for the feedback data object 502 with respect to the evaluation task data object 501.

For example, the feedback evaluation value for a particular feedback data object 502 with respect to a particular evaluation task data object 501 related to patent validity of a particular patent may indicate an inferred conclusion of the feedback data object 502 with respect to the patent validity of the particular patent (e.g., an inferred conclusion indicating one of high likelihood of patentability, low likelihood of patentability, high likelihood of unpatentability, low likelihood of unpatentability, even likelihood of patentability and unpatentability, and/or the like). As another example, the feedback credibility value for a particular feedback data object 502 by a particular evaluator data object 503 with respect to a particular evaluation task data object 501 which relates to patent validity of a particular patent may indicate an inferred credibility of the particular evaluator data object 503 for the feedback data object 502 with respect to the patent validity of the particular patent (e.g., an inferred credibility indicating one of high credibility, moderate credibility, low credibility, and/or the like).

As yet another example, the feedback evaluation value for a particular feedback data object 502 with respect to a particular evaluation task data object 501 related to infringement of a particular patent by a particular activity or product may indicate an inferred conclusion of the feedback data object 502 with respect to infringement of the particular patent by the particular activity or product (e.g., an inferred conclusion indicating one of high likelihood of infringement, low likelihood of infringement, high likelihood of non-infringement, low likelihood of non-infringement, even likelihood of infringement and non-infringement, and/or the like). As a further example, the feedback credibility value for a particular feedback data object 502 by a particular evaluator data object 503 with respect to a particular evaluation task data object 501 which relates to infringement of a particular patent by a particular activity or product may indicate an inferred credibility of the particular evaluator data object 503 for the feedback data object 502 with respect to the infringement of a particular patent by the particular activity or product (e.g., an inferred credibility indicating one of high credibility, moderate credibility, low credibility, and/or the like).

As another example, the feedback evaluation value for a particular feedback data object 502 with respect to a particular evaluation task data object 501 related to an estimated value of a particular patent may indicate an inferred conclusion of the feedback data object 502 with respect to the value of the particular patent (e.g., an inferred conclusion indicating one of high value for the particular patent, low value for the particular patent, the value of the particular patent falling within a particular value range, the value of the particular patent falling within a discrete valuation designation, etc.). As a further example, the feedback credibility value for a particular feedback data object 502 by a particular evaluator data object 503 with respect to a particular evaluation task data object 501 which relates to an estimated value of a particular patent may indicate an inferred credibility of the particular evaluator data object 503 for the feedback data object 502 with respect to determining the estimated value of the particular patent (e.g., an inferred credibility indicating one of high credibility, moderate credibility, low credibility, and/or the like).

In some embodiments, the feedback evaluation value for a feedback data object is determined based at least in part on a domain-specific evaluation range for the evaluation task data object 501, where the domain-specific evaluation range for the evaluation task data object may include one or more domain-specific evaluation designations for the evaluation task (e.g., one or more domain-specific evaluations designations including a domain-specific evaluation designations indicating high likelihood of patentability of a patent, a domain-specific evaluation designations indicating low likelihood of patentability of a patent, a domain-specific evaluation designations indicating high likelihood of unpatentability of a patent, a domain-specific evaluation designations indicating low likelihood of unpatentability of a patent, a domain-specific evaluation designations indicating an even likelihood of patentability and unpatentability of a patent, and/or the like). Thus, in some embodiments, the evaluation task data object 501 may define an output space (e.g., a sentiment space) for itself based at least in part on one or more properties of the evaluation task data object 501, such as task-type property of the evaluation task data object 501. For example, a validity-related evaluation task data object 501 may have an output space that is different from an infringement-related evaluation task data object 501. In some embodiments, an output space defined by an evaluation task data object 501 may be one or more of a Boolean output space, a multi-class output space, and a continuous output space.

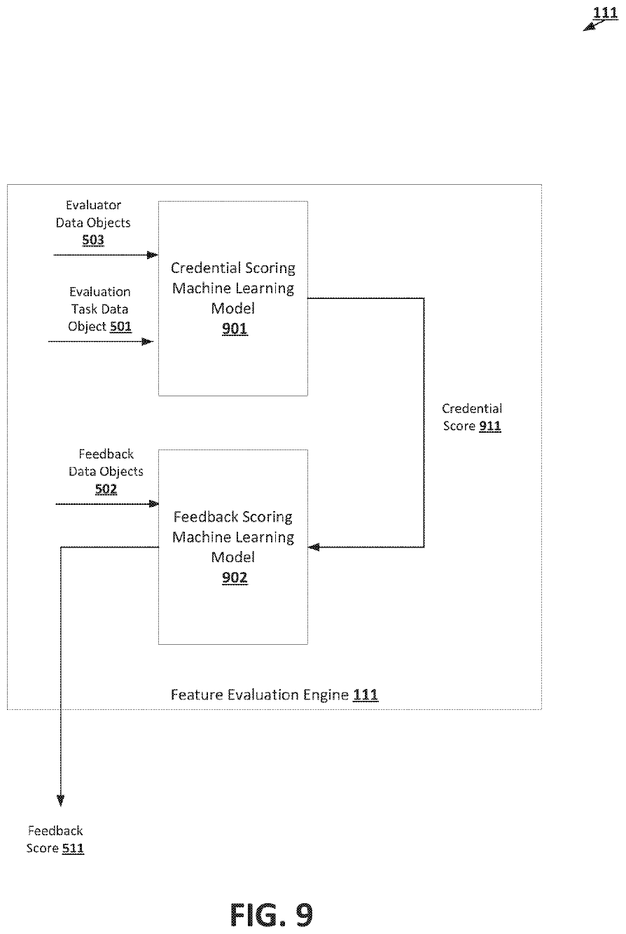

In some embodiments, generating a feedback score 511 for a particular feedback data object 502 can be performed in accordance with the process depicted in the data flow diagram of FIG. 9. As depicted in FIG. 9, the feedback evaluation engine 111 maintains at least two scoring models: a credential scoring machine learning model 901 and a feedback scoring machine learning model 902. The credential scoring machine learning model 901 is configured to process the particular evaluator data object 503 associated with the particular feedback data object 502 and the evaluation task data object 501 to determine a credential score 911 for the evaluator data object 503 with respect to the evaluation task data object 501. In some embodiments, the credential score 911 for the evaluator data object 503 with respect to the evaluation task data object 501 is an inferred measure of credibility of the evaluator data object 503 with respect to a task having one or more task features of the evaluation task data object 501. The feedback scoring machine learning model 902 is further configured to process the particular feedback data object 502 and the credential score 911 for the evaluator data object 503 to determine the feedback score 511 for the particular feedback data object 502.

Each of the credential scoring machine learning model 901 and the feedback scoring machine learning model 902 may include one or more supervised machine learning models and/or one or more unsupervised machine learning models. For example, the credential scoring machine learning model 901 may utilize a clustering-based machine learning model or a trained supervised machine learning model. In some embodiments, the credential scoring machine learning model 901 is a supervised machine learning model (e.g., a neural network machine learning model) trained using one or more ground-truth evaluator data objects, where each ground-truth evaluator data object of the one or more ground-truth evaluator data objects is associated with a plurality of ground-truth evaluator features associated with one or more evaluator feature types and a ground-truth credential score, and where the supervised machine learning model is configured to process one or more evaluator features for the particular evaluator data object to generate the particular credential score.

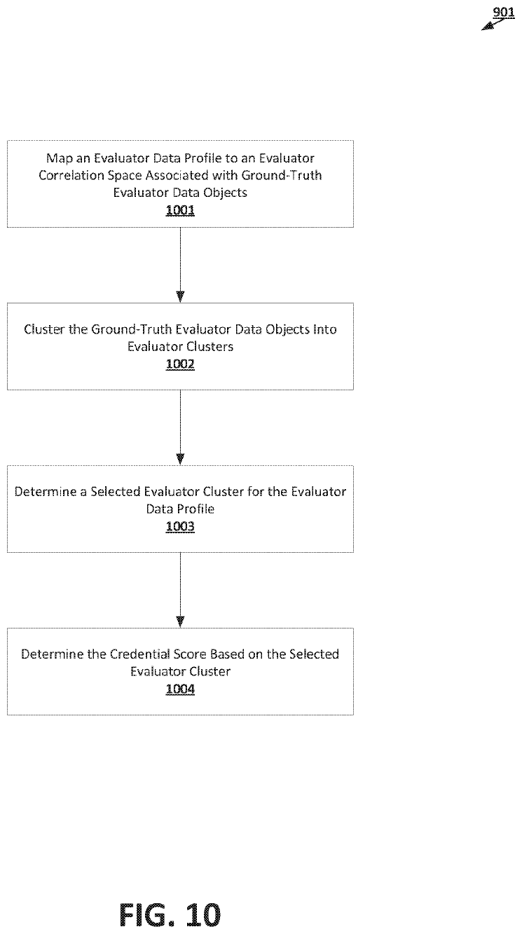

A flowchart diagram of an example process for determining a credential score 911 for a particular evaluator data object 503 in accordance with a clustering-based machine learning model is depicted in FIG. 10. As depicted in FIG. 10, the depicted process begins at step/operation 1001 when the credential scoring machine learning model 901 maps the particular evaluator data object 503 into an evaluator correlation space associated with a group of ground-truth evaluator data objects. The evaluator correlation space may be a multi-dimensional feature space defined by at least some of a group of evaluator feature values for an evaluator data project.

In some embodiments, in order to map the evaluator data object 503 to the evaluator correlation space associated with the group of ground-truth evaluator data objects, the credential scoring machine learning model 901 first determines, based at least in part on the particular evaluator data object 503, one or more evaluator features for the particular evaluator data object, wherein the one or more evaluator features are associated with one or more evaluator feature types. Examples of evaluator features for the particular evaluator data object 503 include evaluator features that indicate competence of the particular evaluator data object 503 with respect to one or more task-types. After determining particular evaluator features having particular evaluator features for the particular evaluator data object 503, the credential scoring machine learning model 901 may identify one or more ground-truth evaluator data objects each associated with one or more evaluator feature values corresponding to the one or more evaluator feature types and a ground-truth credential score for the ground-truth evaluator data object. The credential scoring machine learning model 901 may then map then generate the evaluator correlation space as a space whose dimensions are defined by the particular evaluator feature types and map the particular evaluator data object 503 as well as the ground-truth evaluator data objects to the generated evaluator correlation space based at least in part on the evaluator feature values for the particular evaluator data object 503 and the ground-truth evaluator feature values for the ground-truth evaluator data objects.

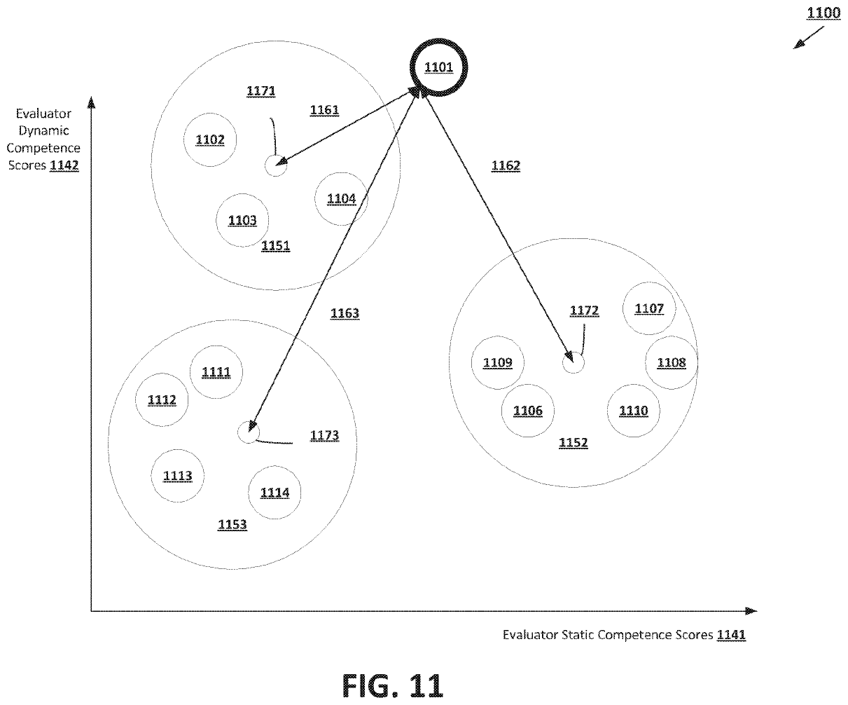

An operational example of an evaluator correlation space 1100 is presented in FIG. 11. As depicted in FIG. 11, the evaluator correlation space 1100 is defined by two-dimensions: an x-dimension that relates to evaluator static competency scores 1141 for modeled evaluator data objects (e.g., the particular evaluator data object 503 as well as the ground-truth evaluator data objects) and a y-dimension that relates to evaluator dynamic competency scores 1142 for the modeled evaluator data objects. In the evaluator correlation space 1100 of FIG. 11, evaluator features of the evaluator data object 503 are modeled using the point 1101, while the ground-truth evaluator features of the ground-truth evaluator data objects are modeled using the points 1102-1114. In particular, each point 1102-1114 indicates (using its x value) the evaluator static competency score for a corresponding ground-truth evaluator data object and (using its y value) the evaluator dynamic competency score for a corresponding ground-truth evaluator data object.

Returning to FIG. 10, at step/operation 1002, the credential scoring machine learning model 901 clusters the ground-truth evaluator data objects into a group of evaluator clusters based at least in part on similarity of ground-truth evaluator features associated with the ground-truth evaluator data objects. For example, as depicted in the evaluator correlation space 1100 of FIG. 11, the ground-truth evaluator data objects may be clustered into an evaluator cluster 1151 (which includes ground-truth evaluator data objects corresponding to the points 1102-1104), the evaluator cluster 1152 (which includes ground-truth evaluator data objects corresponding to the points 1107-1110), and the evaluator cluster 1153 (which includes ground-truth evaluator data objects corresponding to the points 1111-1114).

At step/operation 1003, the credential scoring machine learning model 901 determines a selected evaluator cluster for the evaluator data object 503 from the group of evaluator clusters generated in step/operation 1002. In some embodiments, to determine the selected evaluator cluster for the evaluator data object from the group of evaluator clusters, the credential scoring machine learning model 901 first determines, for each evaluator cluster, a cluster distance value based at least in part on the one or more evaluator features and each one or more evaluator feature values for a ground-truth evaluator data object in the evaluator cluster. For example, the credential scoring machine learning model 901 may determine statistical distribution measures (e.g., means, median, modes, and/or the like) of ground-truth evaluator feature values for each evaluator cluster (e.g., statistical distribution measures 1171-1173 for evaluator clusters 1151-1153 in the evaluator correlation space 1100 of FIG. 11 respectively) and may then subsequently determine a distance measure (e.g., a Euclidean distance measure, such as the Euclidean distance measures 1161-1163 for evaluator clusters 1151-1153 in the evaluator correlation space 1100 of FIG. 11 respectively) between the determined statistical distribution measures for the evaluator clusters and the evaluator feature values of the particular evaluator data object 503.

At step/operation 1004, the credential scoring machine learning model 901 determines the credential score for the particular evaluator data object 503 based at least in part on the selected evaluator cluster for the particular evaluator data object 503. In some embodiments, to determine the credential score the credential score for the particular evaluator data object 503 based at least in part on the selected evaluator cluster for the particular evaluator data object 503, the credential scoring machine learning model 901 first generates a statistical distribution measure of the ground-truth credential scores for the ground-truth evaluator data objects associated with the selected evaluator cluster for the particular evaluator data object 503. Subsequently, the credential scoring machine learning model 901 determines the credential score for the particular evaluator data object 503 based at least in part on the generated statistical distribution measure of the ground-truth credential scores for the ground-truth evaluator data objects associated with the selected evaluator cluster.

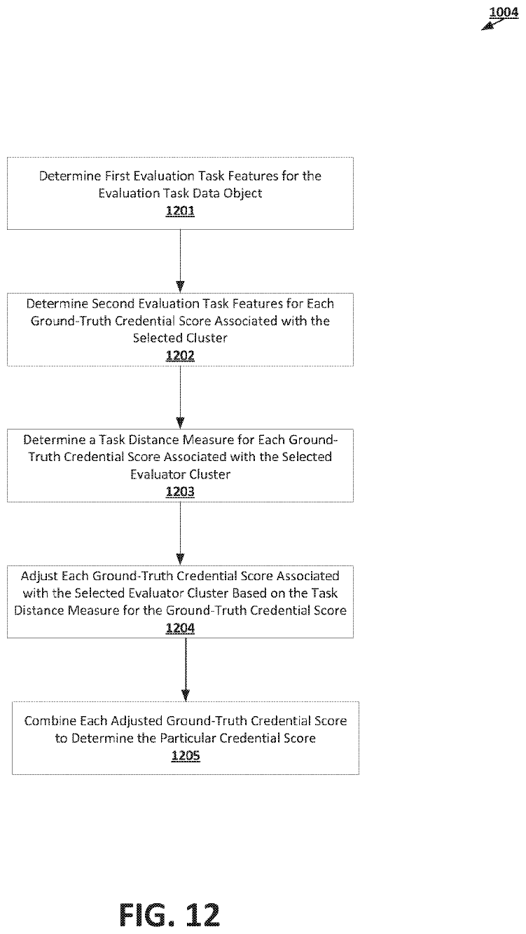

In some embodiments, determining the particular credential score for the particular evaluator data object 503 based at least in part on ground-truth credential scores for the selected evaluator cluster associated with the particular evaluator data object 503 can be performed in accordance with the process depicted in FIG. 12. The process depicted in FIG. 12 begins at step/operation 1201 when the credential scoring machine learning model 901 determines one or more first evaluation task features for the particular evaluation task data object 501 with respect to which the particular credential score 911 is being calculated. In some embodiments, the credential scoring machine learning model 901 determines the first evaluation task features for the particular evaluation task data object 501 based at least in part on the evaluation task data object 501. At step/operation 1202, the credential scoring machine learning model 901 determines one or more second evaluation task features for each ground-truth credential score for the selected evaluator cluster associated with the particular evaluator data object 503. For example, the credential scoring machine learning model 901 may generate one or more second evaluation task features for a ground-truth credential score by processing an evaluation task data object associated with the particular ground-truth credential score.

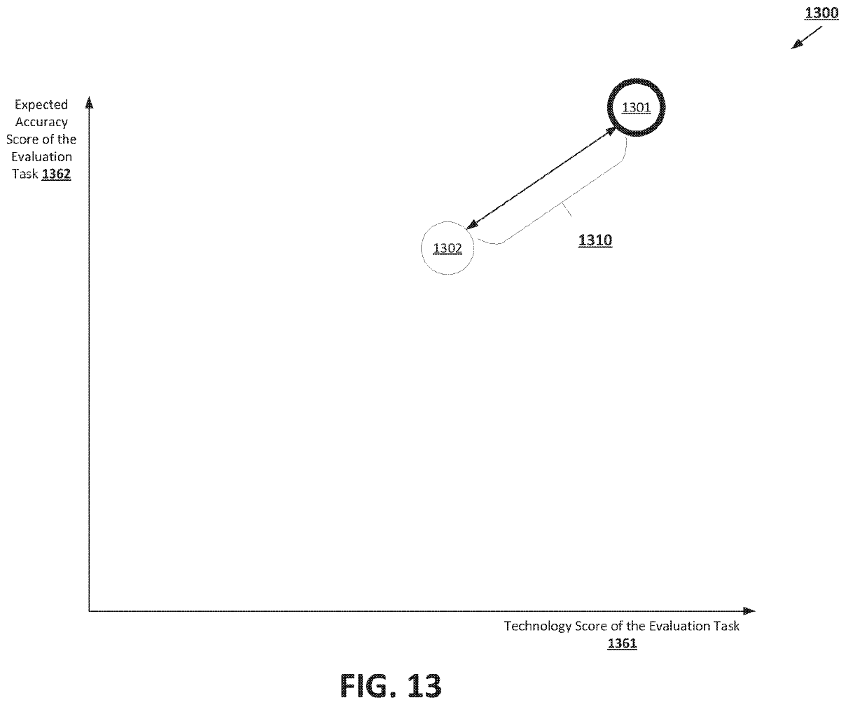

In some embodiments, to perform steps/operations 1201-1202, the credential scoring machine learning model 901 may map task features for the evaluation task data object 501 as well as task features for each ground-truth credential score for the selected cluster to a task feature space, such as the example task feature space 1300 of FIG. 13. As depicted in FIG. 13, the task feature space 1300 models each evaluation task data object (e.g., task data object associated with the evaluation task data object 501 and task data object associated with another evaluation task data object) into a two-dimensional space whose x axis models the technology scores 1361 of evaluation tasks corresponding to the evaluation task data objects and whose y axis models the expected accuracy scores 1362 of the evaluation tasks corresponding to the evaluation task data objects. Given the described dimensional associations of the task feature space 1300, the evaluation task data object 501 is mapped to the point 1301 in the task feature space 1300 while another evaluation task data object (e.g., an evaluation task data object associated with a ground-truth credential score for the selected cluster) is mapped to the point 1302 in the task feature space 1300.

Returning to FIG. 12, at step/operation 1203, the credential scoring machine learning model 901 determines a task distance measure for each ground-truth credential score in the selected evaluator cluster based at least in part on the task distance between the first feature evaluation task features for the particular evaluation task data object 501 and the particular ground-truth credential score. For example, as depicted in the task feature space 1300 of FIG. 13, the credential scoring machine learning model 901 determines the task distance measure 1310 between the first task features of the particular evaluation task data object 501 modeled using the point 1301 of the task feature space 1300 of FIG. 13 and the second task features of another evaluation task data object modeled using point 1302 of the task feature space 1300 of FIG. 13.

At step/operation 1204, the credential scoring machine learning model 901 adjusts each ground-truth credential score based at least in part on the task distance measure for the ground-truth credential score to generate a corresponding adjusted ground-truth credential score. In some embodiments, step/operation 1204 is configured to penalize predictive relevance of ground-truth credential scores related to less related evaluation tasks versus ground-truth credential scores related to more related evaluation tasks. In some embodiments, a ground-truth credential score is only included in the calculation of the particular credential score 911 for the particular evaluator data object 503 if the calculated task distance measure for the ground-truth credential score exceeds a task distance threshold and/or satisfies one or more task distance criteria.

At step/operation 1205, the credential scoring machine learning model 901 combines each adjusted ground-truth credential score for a ground-truth credential score to determine the particular credential score. In some embodiments, to determine the particular credential score, the credential scoring machine learning model 901 determines a statistical distribution measure of each adjusted ground-truth credential score for a ground-truth credential score to determine the particular credential score. In some embodiments, to determine the particular credential score, the credential scoring machine learning model 901 performs a weighed averaging of each adjusted ground-truth credential score for a ground-truth credential score to determine the particular credential score, where the weight averages may be defined by one or more parameters of the credential scoring machine learning model 901, such as one or more trained parameters of the credential scoring machine learning model 901.

Returning to FIG. 9, the feedback scoring machine learning model 902 is configured to process the particular feedback data object 502 and the credential score 911 for the particular evaluator data object 503 associated with the particular feedback data object 502 to generate a feedback score for the particular feedback data object 502. In some embodiments, the feedback score 511 of the particular feedback data object 502 with respect to the evaluation task data object 501 is an estimated measure of contribution of data for the particular feedback data object 502 to resolving an evaluation task defined by the evaluation task data object 501. In some embodiments, each feedback score 511 for the particular feedback data object includes a feedback evaluation value for the particular feedback data object 502 with respect to the evaluation task data object 501 and a feedback credibility value for the particular feedback data object 502 with respect to the evaluation task data object 501. In some embodiments, the feedback evaluation value for the particular feedback data object 502 with respect to the evaluation task data object 501 indicates an inferred conclusion of the particular feedback data object 502 with respect to the evaluation task data object 501. In some embodiments, the feedback credibility value of the particular feedback data object 502 with respect to the evaluation task data object 501 indicates an inferred credibility of the evaluator data object 503 for the feedback data object 502 with respect to the evaluation task data object 501.

Returning to FIG. 5, the feedback aggregation engine 112 is configured to process each feedback score 511 for a feedback data object 502 related to the evaluation task data object 501 to generate a collaborative evaluation 521 for the evaluation task data object 501. In some embodiments, the feedback aggregation engine 112 is configured to perform operations defined by a feedback aggregation machine learning model, where the feedback aggregation machine learning model may be an ensemble machine learning model configured to process the feedback score 511 for each feedback data object 502 associated with the evaluation task data object 501 to generate the collaborative evaluation 521 for the evaluation task data object 501. In some embodiments, the collaborative evaluation 521 for the evaluation task data object 501 includes: (i) a collaborative evaluation value for the evaluation task data object 501 which indicates an evaluation regarding the evaluation task data object 501 inferred based at least in part on the feedback data objects 502 associated with the evaluation task data object 501; and (ii) a collaborative confidence value for the evaluation task data object 501 which indicates a level of inferred confidence in the collaborative evaluation value, e.g., a level of confidence determined based at least in part on the feedback credibility values for the feedback data objects 502 associated with the evaluation task data object 501.

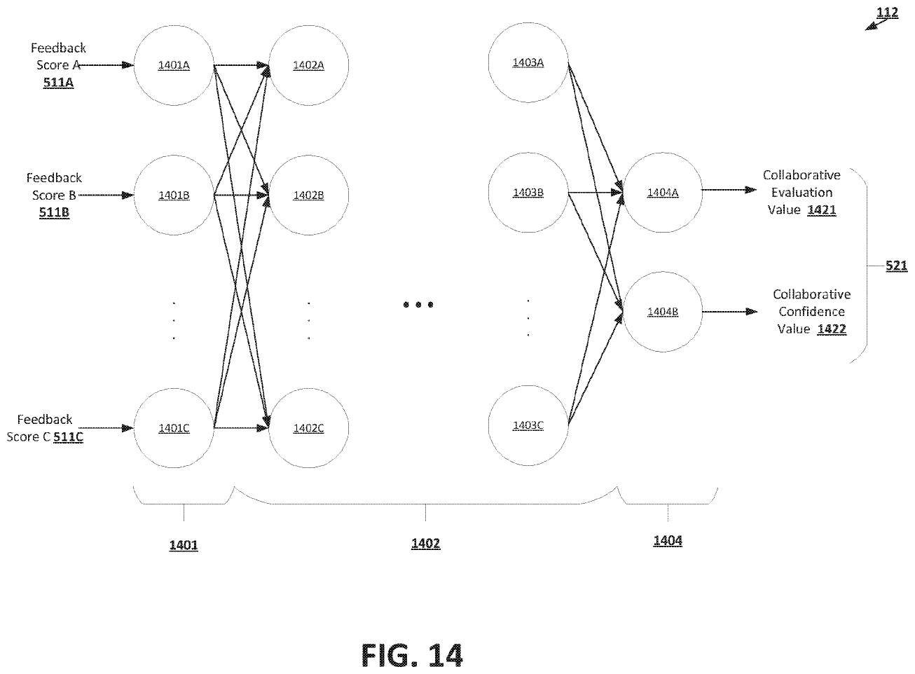

A data flow diagram of an example process for generating a collaborative evaluation 521 for a particular evaluation task data object 501 is presented in FIG. 14. The depicted process includes generating the collaborative evaluation 521 using a neural network machine learning model. As depicted in FIG. 14, the neural network machine learning model includes one or more machine learning nodes (e.g., entities), such as machine learning nodes 1401A-1401C, 1402A-1402C, 1403A-1403C, and 1404A-1404B. Each machine learning node of the neural network machine learning model is configured to receive one or more inputs for the machine learning node, perform one or more linear transformations using the received inputs for the machine learning node and in accordance with one or more node parameters for the machine learning node to generate an activation value for the machine learning node, perform a non-linear transformation using the activation value for the machine learning model to generate an output value for the machine learning node, and provide the output value as an input to at least one (e.g., each) machine learning node in a subsequent machine learning layer of the neural network machine learning model.

The layers of the neural network machine learning model depicted in FIG. 14 include an input layer 1401 having the machine learning nodes 1401A-140C. Each machine learning node of the input layer is configured to receive as input a feedback score for a particular feedback data object 502 associated with the particular evaluation task data object 501. For example, the machine learning node 1401A is configured to receive as input a feedback score 511A for a first feedback data object associated with the particular evaluation task data object 501. As another example, the machine learning node 1401B is configured to receive as input a feedback score 511B for a second feedback data object associated with the particular evaluation task data object 501. As a further example, the machine learning node 1401C is configured to receive as input a feedback score 511C for a third feedback data object associated with the particular evaluation task data object 501.

The layers of the neural network machine learning model depicted in FIG. 14 further include one or more hidden layers 1402, such as the first hidden layer including the machine learning nodes 1402A-1402C and the last hidden layer including the machine learning nodes 1403A-1403C. The layers of the neural network machine learning model further include an output layer 1404 which includes a first output machine learning node 1404A configured to generate, as part of the collaborative evaluation 521 for the evaluation task data object 501, a collaborative evaluation value 1421 for the particular evaluation task data object 501 and a collaborative confidence value 1422 for the particular evaluation task data object 501. In some embodiments, the collaborative evaluation value 1421 for the evaluation task data object 501 indicates an evaluation regarding the evaluation task data object 501 inferred based at least in part on the feedback data objects 502 associated with the evaluation task data object 501. In some embodiments, the collaborative confidence value 1422 for the evaluation task data object 501 indicates a level of inferred confidence in the collaborative evaluation value 1421.

Returning to FIG. 5, the feedback aggregation engine 112 may generate the collaborative evaluation 521 for the evaluation task data object 501 based at least in part on a domain-specific evaluation range for the evaluation task data object. In some of those embodiments, generating the collaborative evaluation 521 includes performing the following operations: (i) for each domain-specific candidate evaluation designation of the one or more domain-specific evaluation designations defined by the domain-specific evaluation range for the evaluation task data object, (a) identifying one or more designated feedback data objects of the one or more feedback data objects for the domain-specific evaluation designation based at least in part on each feedback evaluation value for a feedback data object of the one or more feedback data objects, and (b) generating a designation score for the domain-specific evaluation designation based at least in part on each feedback credibility value for a designated feedback data object of the one or more designated feedback data objects for the domain-specific evaluation designation, and (ii) generating the collaborative evaluation 521 based at least in part on each designation score for a domain-specific evaluation designation of the one or more domain-specific evaluation designations. In some of the noted embodiments, the feedback aggregation engine 112 determines a ratio of the feedback data objects 502 related to an evaluation task data object 501 that have a particular domain-specific candidate evaluation designation and uses the ratio to determine one or more selected domain-specific candidate evaluation designations for the evaluation task data object 501.

The feedback aggregation engine 112 may generate, and provide to the reward generation engine 113, evaluator contribution values 531 for each evaluator data object 503 with respect to the collaborative evaluation 521. In some embodiments, the evaluator contribution value 531 for an evaluator data object 503 with respect to the collaborative evaluation 521 indicates an inferred significance of one or more feedback data objects 502 associated with the evaluator data object 503 to determining the collaborative evaluation 521. In some embodiments, to determine the evaluator contribution value 531 for an evaluator data object 503 with respect to the collaborative evaluation 521, the feedback aggregation engine 112 takes into account at least one of the following: (i) the credential score 911 of the evaluator data object 503 with respect to the evaluation task data object 501 associated with the collaborative evaluation 521, (ii) the preconfigured competence distribution for the evaluator data object 503, (iii) the dynamic competence distribution for the evaluator data object 503, (iv) the feedback scores 511 for any feedback data objects 502 used to generate the collaborative evaluation 521 which are also associated with the evaluator data object 503, and (v) the feedback scores 511 for any feedback data objects 502 associated with the evaluation task data object 501 for the collaborative evaluation 521 which are also associated with the evaluator data object 503.

The feedback aggregation engine 112 may generate, and provide to the reward generation engine 113, an evaluation utility determination 532 for the collaborative evaluations 521. An evaluation utility determination 532 for a collaborative evaluation 521 may be determined based at least in part on any benefits accrued by generating the collaborative evaluation 521 for an evaluation task data object 501. For example, the evaluation utility determination 532 for a collaborative evaluation 521 may be determined based at least in part on the monetary reward generated by the collaborative evaluation computing entity 106 as a result of generating the collaborative evaluation 521. As another example, the evaluation utility determination 532 for a collaborative evaluation 521 may be determined based at least in part on the increased user visitation reward generated by the collaborative evaluation computing entity 106 as a result of generating the collaborative evaluation 521. As a further example, the evaluation utility determination 532 for a collaborative evaluation 521 may be determined based at least in part on the increased user registration reward generated by the collaborative evaluation computing entity 106 as a result of generating the collaborative evaluation 521.

The reward generation engine 113 may be configured to process the evaluator contribution for each evaluator data object 503 and the evaluation utility determination 532 for the collaborative evaluation 521 to generate an evaluator reward determination 541 for the particular evaluator data object 503. In some embodiments, the reward generation engine 113 determines how much to reward (e.g., financially, using service tokens, using discounts, and/or the like) each evaluator data object 503 based at least in part on the perceived contribution of the evaluator data object 503 to the collaborative evaluation 521 and based at least in part on the perceived value of the collaborative evaluation 521. In some embodiments, by processing the evaluator contribution for each evaluator data object 503 and the evaluation utility determination 532 for the collaborative evaluation 521 to generate the evaluator reward determination 541 for the particular evaluator data object 503, the reward generation engine 113 can enable generating blockchain-based systems of collaborative evaluation and/or blockchain-based systems of collaborative prediction.

### V. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating a collaborative evaluation for an evaluation task data object, the computer-implemented method comprising:
for each evaluator data object of a plurality of one or more evaluator data objects, processing, by a credential scoring machine learning model, the corresponding evaluator data object and an evaluation task data object to generate a corresponding credential score for the corresponding evaluator data object with respect to the evaluation task data object;
for each feedback data object of one or more feedback data objects associated with a corresponding evaluator data object, processing, by a feedback scoring machine learning model, the corresponding feedback data object and the corresponding credential score for the corresponding evaluator data object to generate a feedback score; and
processing, by a feedback aggregation machine learning model, each feedback score for a feedback data object to generate the collaborative evaluation for the evaluation task data object.

2. The computer-implemented method of claim 1, wherein processing the corresponding evaluator data object by the credential scoring machine learning model to generate the corresponding credential score for the corresponding evaluator data object comprises:
determining, based at least in part on the corresponding evaluator data object, one or more evaluator features for the corresponding evaluator data object, wherein the one or more evaluator features are associated with one or more evaluator feature types;
mapping the one or more evaluator features to an evaluator correlation space for the evaluation task data object to generate a mapped evaluator correlation space for the evaluation task data object, wherein: (i) the evaluator correlation space indicates a plurality of evaluator dimension values for each ground-truth evaluator data object of one or more ground-truth evaluator data objects, and (ii) each plurality of evaluator dimension values for a ground-truth evaluator data object of the one or more ground-truth evaluator data objects comprises one or more evaluator feature values corresponding to the one or more evaluator feature types and a ground-truth credential score for the ground-truth evaluator data object; and
generating the corresponding credential score based at least in part on the mapped evaluator correlation space.

3. The computer-implemented method of claim 2, generating the corresponding credential score based at least in part on the mapped evaluator correlation space comprises:
clustering the one or more ground-truth evaluator data objects into a plurality of evaluator clusters based at least in part on each one or more evaluator feature values for a ground-truth evaluator data object of one or more ground-truth evaluator data objects;
for each evaluator cluster of the plurality of evaluator clusters, determining a cluster distance value based at least in part on the one or more evaluator features and each one or more evaluator feature values for a ground-truth evaluator data object in the evaluator cluster;
determining a selected cluster of the plurality of evaluator clusters for the corresponding evaluator data object based at least in part on each cluster distance value for an evaluator cluster of the plurality of evaluator clusters; and
determining the corresponding credential score based at least in part on each ground-truth credential score for a ground-truth evaluator data object in the selected evaluator cluster.

4. The computer-implemented method of claim 3, wherein determining the corresponding credential score based at least in part on each ground-truth credential score for a ground-truth evaluator data object in the selected evaluator cluster comprises:
determining one or more first evaluation task features for the evaluation task data object based at least in part on the evaluation task data object;
determining one or more second evaluation task features for each ground-truth credential score;
determining a task distance measure for each ground-truth credential score based at least in part on a task distance between the one or more first evaluation task features and the one or more second evaluation task features for the ground-truth credential score;
adjusting each ground-truth credential score based at least in part on the task distance measure for the ground-truth credential score to generate a corresponding adjusted ground-truth credential score; and
combining each adjusted ground-truth credential score for a ground-truth credential score to determine the corresponding credential score.

5. The computer-implemented method of claim 1, wherein each ground-truth credential score for a ground-truth evaluator data object of the one or more ground-truth evaluator data objects is associated with the evaluation task data object.

6. The computer-implemented method of claim 1, wherein:
each evaluator data object of the one or more evaluator data objects is associated with a plurality of evaluator features, and
the plurality of evaluator features for a corresponding evaluator data object of the one or more evaluator data objects comprise: (i) a preconfigured competence distribution for the corresponding evaluator data object with respective to a plurality of competence designations, and (ii) a dynamic competence distribution for the corresponding evaluator data object with respective to the plurality of competence designations.

7. The computer-implemented method of claim 6, wherein the dynamic competence distribution for the corresponding evaluator data object is determined using an online scoring machine learning model configured to sequentially update the dynamic competence distribution based at least in part on one or more incoming feedback evaluation data objects.

8. The computer-implemented method of claim 7, wherein the online scoring machine learning model is a follow-the-regularized-leader online machine learning model.

9. The computer-implemented method of claim 1, wherein:
the credential scoring machine learning model is a supervised machine learning model trained using one or more ground-truth evaluator data objects;
each ground-truth evaluator data object of the one or more ground-truth evaluator data objects is associated with a plurality of ground-truth evaluator features associated with one or more evaluator feature types and a ground-truth credential score;
the supervised machine learning model is configured to process one or more evaluator features for the corresponding evaluator data object to generate the corresponding credential score.

10. The computer-implemented method of claim 1, wherein:
each feedback score for a feedback data object of the one or more feedback data objects object comprises a feedback evaluation value for the feedback data object with respect to the evaluation task data object and a feedback credibility value of the feedback data object with respect to the evaluation task data object;
the feedback evaluation value is determined based at least in part on a domain-specific evaluation range for the evaluation task data object; and
the domain-specific evaluation range for the evaluation task data object comprises one or more domain-specific evaluation designations for the evaluation task.

11. The computer-implemented method of claim 10, wherein generating the collaborative evaluation by the feedback aggregation machine learning model comprises:
for each domain-specific candidate evaluation designation of the one or more domain-specific evaluation designations;
identifying one or more designated feedback data objects of the one or more feedback data objects for the domain-specific evaluation designation based at least in part on each feedback evaluation value for a feedback data object of the one or more feedback data objects; and
generating a designation score for the domain-specific evaluation designation based at least in part on each feedback credibility value for a designated feedback data object of the one or more designated feedback data objects for the domain-specific evaluation designation; and
generating the collaborative evaluation based at least in part on each designation score for a domain-specific evaluation designation of the one or more domain-specific evaluation designations.

12. The computer-implemented method of claim 1, further comprising:
for each evaluator data object of the plurality of evaluator data objects, generating an evaluator contribution; and
determining an evaluation utility determination for the collaborative evaluation, and processing, by a reward generation machine learning model, the evaluator contribution for each evaluator data object of the plurality of evaluator data objects and the evaluation utility determination for the collaborative evaluation to generate an evaluator reward determination for the corresponding evaluator data object.

13. The computer-implemented method of claim 1, wherein:
the evaluation task data object is associated with a validity prediction for an intellectual property asset, and
the one or more feedback data objects for the evaluation task data object comprise at least one expert validity opinion associated with the intellectual property asset.

14. The computer-implemented method of claim 1, wherein:
the evaluation task data object is associated with an infringement prediction for an intellectual property asset, and
the one or more feedback data objects for the evaluation task data object comprise at least one expert infringement opinion associated with the intellectual property asset.

15. The computer-implemented method of claim 1, wherein:
the evaluation task data object is associated with a value prediction for an intellectual property asset, and
the one or more feedback data objects for the evaluation task data object comprise at least one expert valuation opinion associated with the intellectual property asset.

16. An apparatus for generating a collaborative evaluation for an evaluation task data object, the apparatus comprising at least one processor and at least one memory including program code, the at least one memory and the program code configured to, with the processor, cause the apparatus to at least:
for each evaluator data object of one or more evaluator data objects, process, by a credential scoring machine learning model, the corresponding evaluator data object and an evaluation task data object to generate a credential score for the corresponding evaluator data object with respect to the evaluation task data object;
for each feedback data object of one or more feedback data objects associated with a corresponding evaluator data object, process, by a feedback scoring machine learning model, the corresponding feedback data object and the credential score for the corresponding evaluator data object to generate a feedback score; and
process, by a feedback aggregation machine learning model, each feedback score for a feedback data object to generate the collaborative evaluation for the evaluation task data object.

17. The apparatus of claim 17, wherein processing the corresponding evaluator data object by the credential scoring machine learning model to generate the corresponding credential score for the corresponding evaluator data object comprises:
determining, based at least in part on the corresponding evaluator data object, one or more evaluator features for the corresponding evaluator data object, wherein the one or more evaluator features are associated with one or more evaluator feature types;
mapping the one or more evaluator features to an evaluator correlation space for the evaluation task data object to generate a mapped evaluator correlation space for the evaluation task data object, wherein: (i) the evaluator correlation space indicates a plurality of evaluator dimension values for each ground-truth evaluator data object of one or more ground-truth evaluator data objects, and (ii) each plurality of evaluator dimension values for a ground-truth evaluator data object of the one or more ground-truth evaluator data objects comprises one or more evaluator feature values corresponding to the one or more evaluator feature types and a ground-truth credential score for the ground-truth evaluator data object; and
generating the corresponding credential score based at least in part on the mapped evaluator correlation space.

18. A computer program product for generating a collaborative evaluation for an evaluation task data object, the computer program product comprising at least one non-transitory computer-readable storage medium having computer-readable program code portions stored therein, the computer-readable program code portions configured to:
for each evaluator data object of one or more evaluator data objects, process, by a credential scoring machine learning model, the corresponding evaluator data object and an evaluation task data object to generate a credential score for the corresponding evaluator data object with respect to the evaluation task data object;
for each feedback data object of one or more feedback data objects associated with a corresponding evaluator data object, process, by a feedback scoring machine learning model, the corresponding feedback data object and the credential score for the corresponding evaluator data object to generate a feedback score; and
process, by a feedback aggregation machine learning model, each feedback score for a feedback data object to generate the collaborative evaluation for the evaluation task data object.

19. The computer program product of claim 18, wherein processing the corresponding evaluator data object by the credential scoring machine learning model to generate the corresponding credential score for the corresponding evaluator data object comprises:
determining, based at least in part on the corresponding evaluator data object, one or more evaluator features for the corresponding evaluator data object, wherein the one or more evaluator features are associated with one or more evaluator feature types;
mapping the one or more evaluator features to an evaluator correlation space for the evaluation task data object to generate a mapped evaluator correlation space for the evaluation task data object, wherein: (i) the evaluator correlation space indicates a plurality of evaluator dimension values for each ground-truth evaluator data object of one or more ground-truth evaluator data objects, and (ii) each plurality of evaluator dimension values for a ground-truth evaluator data object of the one or more ground-truth evaluator data objects comprises one or more evaluator feature values corresponding to the one or more evaluator feature types and a ground-truth credential score for the ground-truth evaluator data object; and
generating the corresponding credential score based at least in part on the mapped evaluator correlation space.
